(19) United States
(12) Patent Application Publication
(10) Pub. No.: US 2026/0239043 A1
(43) Pub. Date: Aug. 13, 2026

(54) METHOD FOR PROCESSING INFORMATION AND APPARATUS

(71) Applicant: BEIJING XIAOMI MOBILE SOFTWARE CO., LTD., Beijing (CN)

(72) Inventors: Qin MU, Beijing (CN); Min LIU, Beijing (CN)

(21) Appl. No.: 19/157,260

(22) PCT Filed: Feb. 17, 2023
(86) PCT No.: PCT/CN2023/076995

§ 371 Date: Aug. 15, 2025

(51) Int. Cl. H04W 24/06; H04B 7/06

(52) U.S. Cl. CPC H04W 24/06; H04B 7/0658

(57) ABSTRACT

A method for processing information and an apparatus are provided. The method includes: receiving first auxiliary information sent by a network side, where the first auxiliary information is used for performance testing when an encoder and a decoder are jointly used; the encoder is deployed at a terminal side and used to compress channel state information; and the decoder is deployed at the network side and used to decompress the channel state information compressed by the encoder.

### CROSS-REFERENCE TO RELATED APPLICATIONS

The present application is a U.S. national phase of International Application No. PCT/CN2023/076995, filed on Feb. 17, 2023, the entire content of which is incorporated herein by reference for all purposes.

### FIELD

The present disclosure relates to the field of communication technologies, and particularly to a method for processing information and an apparatus.

### BACKGROUND

In 5G systems, obtaining Channel State Information (CSI) is a crucial step. CSI provides information such as the number of information streams a channel can carry, channel quality or signal-to-noise ratio, and the channel matrix. As the number of antennas increases, the overhead for CSI feedback also increases, particularly for the Precoding Matrix Indication (PMI) which represents the channel matrix. Currently, both academia and industry focus on efficient feedback of the channel matrix.

### SUMMARY

A first aspect of embodiments of the present disclosure provides a method for processing information, performed by a terminal side, including:
receiving first auxiliary information sent by a network side, where the first auxiliary information is used for performance testing when an encoder and a decoder are jointly used;
the encoder is deployed at a terminal side and used to compress channel state information; and the decoder is deployed at the network side and used to decompress the channel state information compressed by the encoder.

In some embodiments of the present disclosure, the method further includes:
compressing channel sample information by the encoder, where the channel sample information is the channel state information used for performance testing.

In some embodiments of the present disclosure, the method further includes: the first auxiliary information includes a reference signal, and the method further includes:
receiving the reference signal sent by the network side, where the reference signal is used to measure and obtain the channel sample information.

In some embodiments of the present disclosure, the channel sample information is predefined channel state information, or, the channel sample information is channel sample information sent by the network side.

In some embodiments of the present disclosure, the method further includes:

decompressing the compressed channel sample information using a decoder sent by the network side to obtain decompressed information; or,
in response to the first auxiliary information including decompressed information, receiving the decompressed information sent by the network side, where the decompressed information is information obtained by decompressing the compressed channel sample information by the decoder at the network side.

In some embodiments of the present disclosure, the first auxiliary information includes the decoder, and the method further includes:
receiving the decoder sent by the network side.

In some embodiments of the present disclosure, the method further includes:
sending the compressed channel sample information to the network side.

In some embodiments of the present disclosure, the method further includes:
comparing the decompressed information with the channel sample information before compression to obtain first performance test information when the encoder and the decoder are jointly used; and
comparing the first performance test information with a preset performance requirement to determine whether performance requirements are met when the encoder and the decoder are jointly used.

In some embodiments of the present disclosure, the method further includes:
sending the first performance test information to the network side; or
sending the channel sample information before compression to the network side.

In some embodiments of the present disclosure, the method further includes:
sending a preset performance requirement to the network.

In some embodiments of the present disclosure, the method further includes:
receiving indication information from the network side, where the indication information is used to indicate whether performance requirements are met when the encoder and the decoder are jointly used.

In some embodiments of the present disclosure, the method further includes:
in response to the first auxiliary information including second performance test information when the encoder and the decoder are jointly used, receiving the second performance test information sent by the network side, where the second performance test information is obtained by comparing decompressed information with channel sample information before compression at the network side; and
comparing the second performance test information with the preset performance requirement to determine whether performance requirements are met when the encoder and the decoder are jointly used.

In some embodiments of the present disclosure, the preset performance requirement includes at least one of:
a preset value;
a performance corresponding to a Type II CSI rule;
a performance corresponding to an eType II CSI rule;
a network-side defined value; or
a terminal-side defined value.

In some embodiments of the present disclosure, the method further includes:
sending a first auxiliary performance test request to the network side, where the first auxiliary performance test request is used to request the network side to send the first auxiliary information.

A second aspect of embodiments of the present disclosure provides a method for processing information, performed by a network side, including:

receiving second auxiliary information sent by a terminal side, where the second auxiliary information is used for performance testing when an encoder and a decoder are jointly used;
the encoder is deployed at a terminal side and used to compress channel state information; and the decoder is deployed at the network side and used to decompress the channel state information compressed by the encoder.

In some embodiments of the present disclosure, the method further includes:
sending a reference signal to the terminal side, where the reference signal is used to measure and obtain channel sample information, and the channel sample information is channel state information used for the performance testing.

In some embodiments of the present disclosure, the channel sample information is predefined channel state information, or, the channel sample information is channel sample information sent by the network side.

In some embodiments of the present disclosure, the method further includes:
sending the decoder to the terminal side, where the decoder is used by the terminal side to decompress compressed channel sample information to obtain decompressed information.

In some embodiments of the present disclosure, the second auxiliary information includes compressed channel sample information, and the method further includes:
receiving the compressed channel sample information sent by the terminal side, where the compressed channel sample information is information obtained by compressing channel sample information by the encoder at the terminal side.

In some embodiments of the present disclosure, the method further includes:
decompressing the compressed channel sample information by the decoder to obtain decompressed information; and
sending the decompressed information to the terminal side.

In some embodiments of the present disclosure, the second auxiliary information includes first performance test information when the encoder and the decoder are jointly used or channel sample information before compression, and the method further includes:
receiving the first performance test information sent by the terminal side, where the first performance test information is information obtained by comparing decompressed information with the channel sample information before compression by the terminal side; or
receiving the channel sample information before compression sent by the terminal side.

In some embodiments of the present disclosure, the method further includes:
receiving a preset performance requirement sent by the terminal side.

In some embodiments of the present disclosure, the method further includes:
comparing the first performance test information with a preset performance requirement to determine whether performance requirements are met when the encoder and the decoder are jointly used.

In some embodiments of the present disclosure, the method further includes:
comparing the decompressed information with the channel sample information before compression to obtain second performance test information when the encoder and the decoder are jointly used; and
comparing the second performance test information with a preset performance requirement to determine whether performance requirements are met when the encoder and the decoder are jointly used.

In some embodiments of the present disclosure, the method further includes:
sending the second performance test information to the terminal device.

In some embodiments of the present disclosure, the method further includes:
sending indication information to the terminal side, where the indication information is used to indicate whether performance requirements are met when the encoder and the decoder are jointly used.

In some embodiments of the present disclosure, the preset performance requirement includes at least one of:
a preset value;
a performance corresponding to a Type II CSI rule;
a performance corresponding to an eType II CSI rule;
a network-side defined value; or
a terminal-side defined value.

In some embodiments of the present disclosure, the method further includes:
sending a second auxiliary performance test request to the terminal side, where the second auxiliary performance test request is used to request the terminal side to send the second auxiliary information.

A third aspect of embodiments of the present disclosure provides an information processing apparatus, applied at a terminal side, the apparatus including:
a receiving module configured to receive first auxiliary information sent by a network side, where the first auxiliary information is used for performance testing when an encoder and a decoder are jointly used;
the encoder is deployed at a terminal side and used to compress channel state information; and the decoder is deployed at the network side and used to decompress the channel state information compressed by the encoder.

A fourth aspect of embodiments of the present disclosure provides an information processing apparatus, applied at a network side, the apparatus including:
a receiving module configured to receive second auxiliary information sent by a terminal side, where the second auxiliary information is used for performance testing when an encoder and a decoder are jointly used;
the encoder is deployed at a terminal side and used to compress channel state information; and the decoder is deployed at the network side and used to decompress the channel state information compressed by the encoder.

A fifth aspect of embodiments of the present disclosure provides a communication device, including: a transceiver; a memory; and a processor, connected to the transceiver and the memory, configured to control wireless signal transmission and reception of the transceiver by executing computer-executable instructions in the memory and perform the method according to any one of the embodiments of the first aspect or the second aspect.

A sixth aspect of embodiments of the present disclosure provides a computer storage medium, having stored therein computer-executable instructions that, when executed by a processor, cause the method according to any one of the embodiments of the first aspect or the second aspect to be implemented.

### BRIEF DESCRIPTION OF THE DRAWINGS

The above and/or additional aspects and advantages of the present disclosure will become apparent and readily understood from the description of the embodiments in conjunction with the drawings, wherein:

FIG. 1 is a schematic flowchart illustrating the principle of CSI compression according to an embodiment of the present disclosure;

FIG. 2 is a schematic flowchart of a method for processing information according to an embodiment of the present disclosure;

FIG. 3 is a schematic flowchart of a method for processing information according to an embodiment of the present disclosure;

FIG. 4 is a schematic flowchart of a method for processing information according to an embodiment of the present disclosure;

FIG. 5 is a schematic flowchart of a method for processing information according to an embodiment of the present disclosure;

FIG. 6 is a schematic flowchart of a method for processing information according to an embodiment of the present disclosure;

FIG. 7 is a schematic flowchart of a method for processing information according to an embodiment of the present disclosure;

FIG. 8 is a schematic flowchart of a method for processing information according to an embodiment of the present disclosure;

FIG. 9 is a schematic flowchart of a method for processing information according to an embodiment of the present disclosure;

FIG. 10 is a sequence diagram of a method for processing information according to an embodiment of the present disclosure;

FIG. 11 is a sequence diagram of a method for processing information according to an embodiment of the present disclosure;

FIG. 12 is a sequence diagram of a method for processing information according to an embodiment of the present disclosure;

FIG. 13 is a sequence diagram of a method for processing information according to an embodiment of the present disclosure;

FIG. 14 is a block diagram of an information processing apparatus according to an embodiment of the present disclosure;

FIG. 15 is a block diagram of an information processing apparatus according to an embodiment of the present disclosure;

FIG. 16 is a schematic structural diagram of a communication device according to an embodiment of the present disclosure; and

FIG. 17 is a schematic structural diagram of a chip provided by an embodiment of the present disclosure.

### DETAILED DESCRIPTION

The embodiments of the present disclosure are described in detail below. Examples of the embodiments are illustrated in the drawings, where the same or similar reference numerals throughout denote the same or similar elements or elements having the same or similar functions. The embodiments described below with reference to the drawings are exemplary and are intended to explain the present disclosure, but should not be construed as limiting the present disclosure.

The embodiments of the present application are described in detail below. Examples of the embodiments are illustrated in the drawings, where the same or similar reference numerals throughout denote the same or similar elements or elements having the same or similar functions. The embodiments described below with reference to the drawings are exemplary and are intended to explain the present application, but should not be construed as limiting the present application. It should be noted that, in the case of no conflict, the embodiments of the present application and the features in the embodiments may be combined with each other.

The terms used in the embodiments of the present application are only for the purpose of describing specific embodiments, and are not intended to limit the embodiments of the present application. The singular forms “a”, “an” and “the” used in the embodiments of the present application and the appended claims are also intended to include plural forms, unless the context clearly indicates otherwise. It should also be understood that the term “and/or” as used herein refers to and includes any or all possible combinations of one or more associated listed items.

It should be understood that although the terms first, second, third, etc. may be used in the embodiments of the present application to describe various information, this information should not be limited by these terms. These terms are only used to distinguish information of the same type from one another. For example, without departing from the scope of the embodiments of the present application, first information may also be referred to as second information, and similarly, second information may also be referred to as first information. Depending on the context, the word “if” as used herein may be interpreted as “when” or “upon” or “in response to determining”.

In 5G systems, obtaining Channel State Information (CSI) is a crucial step. CSI provides information such as the number of information streams a channel can carry, channel quality or signal-to-noise ratio, and the channel matrix. As the number of antennas increases, the overhead for CSI feedback also increases, particularly for the matrix representing the channel matrix, the Point-wise Mutual Information (PMI). Currently, both academia and industry focus on efficient feedback of the channel matrix.

The 3rd Generation Partnership Project (3GPP) has currently standardized Type I codebooks and Type II codebooks for channel matrix feedback. The current CSI feedback mechanisms such as Type I/II codebooks have the following problems and shortcomings:
1) Both Type I and Type II codebooks are based on Discrete Fourier Transform (DFT) vectors, which assume that the antenna array is divided into horizontal and vertical dimensions, and the antennas are uniformly arranged in each dimension. That is, the current Type I/II codebooks are only suitable for neatly arranged base station antenna arrays and are not suitable for 3G base station antennas, special-shaped antennas, large-scale distributed antennas, etc. This imposes significant limitations on subsequent antenna hardware design and prevents optimization for special antennas in different scenarios.
2) The design of Type I/II codebooks is based on the assumption of uniform distribution of signal incident and departure angles. However, in actual environments, the statistical patterns of signal arrival and departure angles are not uniformly distributed, and they differ for each base station device, leaving room for optimization. For example, if signals in certain angular ranges of arrival and departure angles have a high probability of occurrence, the codebook should be designed densely in these angular ranges; conversely, if signals in certain angular ranges have a low probability, the codebook should be designed sparsely in those ranges.
3) Type I and Type II codebooks have their respective application scopes. The Type I codebook is simpler but has limited accuracy and is designed for single-user transmission. The Type II codebook has high accuracy and can be used for multi-user transmission. Using accurate channel feedback, interference between multiple users can be effectively eliminated. However, its overhead is too large, leaving significant room for optimization.

For the embodiments of the present disclosure, as a possible application scenario, Artificial Intelligence (AI) technology can be introduced to effectively solve these problems, for the following reasons:
1) For non-neatly arranged base station antenna arrays, channel data can be obtained through simulation modeling, field data collection, etc., and specialized AI network training can be performed to obtain a matching AI network.
2) For complex real-world scenarios, dedicated optimization for a specific base station can also be performed through field data collection.
3) For different scenarios and requirements, different feedback bits can be used to train the AI network to achieve channel matrix feedback with arbitrary feedback bits and arbitrary accuracy requirements.

Using AI for CSI compression, as shown in FIG. 1, the specific implementation process is as follows:

An encoder (encoder) is deployed at the terminal side to compress the measured CSI information, which is then transmitted to the network side (e.g., base station) via a channel;

A decoder (decoder) is deployed at the base station side to decompress the compressed CSI information, obtaining predicted CSI, attempting to make the predicted CSI infinitely close to the CSI before compression, i.e., restored to its pre-compression state.

However, this approach has certain technical defects:
1) In the training methods for this use case, one method is separate training, where the terminal side and the base station side train the encoder and decoder independently based on the same dataset.
2) To protect the privacy of the AI model, the terminal side or the network side does not know the information of the other party's encoder or decoder. During the model training process, the terminal side builds its own encoder and decoder to train the AI model. After testing meets the requirements, the terminal side uses the corresponding encoder for CSI compression. The base station side does the same.
3) However, during the specific inference process, the actual encoder or decoder used may not be the one used during training, which may result in poor inference performance, affecting the user experience. Here, the inference process refers to restoring the information before compression at the network side, and poor inference performance means that the output of the decoder at the network side differs significantly from the input of the encoder at the terminal side.

In view of this, as a possible application scenario, this embodiment proposes a channel state information processing method and apparatus, used for AI joint training between the network side and the terminal side. Specifically, before using AI for CSI compression, the decoder at the network side and the encoder at the terminal side are jointly trained. During the training process, relevant mechanisms are designed to support the connection between the terminal-side encoder and the base station-side decoder, and the connection performance is tested before formal application. Only when the performance requirements are met are the encoder and decoder used for CSI transmission, thereby ensuring accurate and efficient feedback of channel state information.

To this end, this embodiment proposes a method for processing information and apparatus, capable of solving the technical problem of low accuracy in channel state information feedback.

It is understandable that the solution provided by the present disclosure can be applied to the terminal side, such as a terminal device (User Equipment, UE) or other executable entities. In the following embodiments of the present disclosure, the technical solution of the present disclosure is described by taking the execution subject as the terminal side as an example, but this does not constitute a specific limitation. In the present disclosure, the terminal device may be a mobile phone, notebook, tablet computer, POS machine, vehicle-mounted computer, or other communication device, which is not limited in the present disclosure.

The information processing method and apparatus provided by the present application are described in detail below with reference to the drawings.

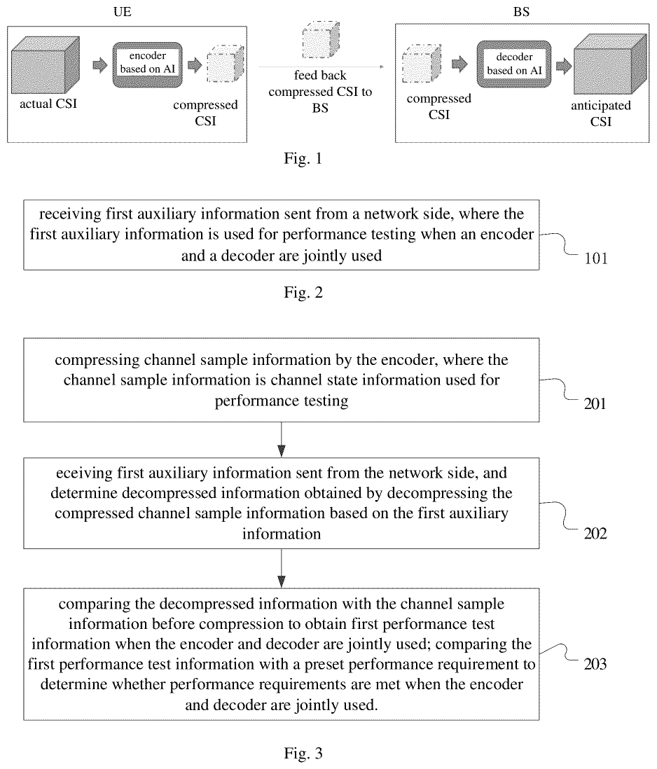

FIG. 2 shows a schematic flowchart of a method for processing information according to an embodiment of the present disclosure. As shown in FIG. 2, the method is applied to the terminal side and may include the following steps.

Step 101: receiving first auxiliary information sent by a network side, where the first auxiliary information is used for performance testing when an encoder and a decoder are jointly used.

The encoder is deployed at a terminal side and used to compress channel state information; and the decoder is deployed at the network side and used to decompress the channel state information compressed by the encoder. The first auxiliary information is used by the terminal side to determine channel sample information, or to determine first performance test information when the encoder and decoder are jointly used, or to determine whether performance requirements are met when the encoder and decoder are jointly used, which is not specifically limited here. The first auxiliary information may include one or more of: a reference signal for measuring channel sample information, a decoder for decompression processing, decompressed information, second performance test information when the encoder and decoder are jointly used, or may also include other auxiliary information, which is not specifically limited here. In specific application scenarios, the terminal side may send a first auxiliary performance test request to the network side, where the first auxiliary performance test request is used to cause the network side to send the first auxiliary information.

For the embodiments of the present disclosure, the terminal side can obtain the channel state information (i.e., channel sample information) used for performance testing based on the first auxiliary information sent by the network side. Then, by using the channel sample information for performance testing when the encoder and decoder are jointly used, it determines whether the performance requirements are met when the encoder and decoder are jointly used. When the terminal side obtains the channel sample information, as one possible implementation, the network side may, in response to a first auxiliary performance test request sent by the terminal side, send a reference signal for channel state information measurement to the terminal side. The terminal side can obtain the channel sample information by measuring the reference signal. The reference signal may be, for example, a Channel-State-Information Reference Signal (CSI-RS), which is not specifically limited here. In another embodiment, the channel sample information may also be predefined channel state information. For example, the terminal side may obtain an offline test dataset and extract channel sample information from the test dataset. The test dataset pre-stores CSI actually measured by the terminal, such as full channel information, or feature vectors processed from the full channel information. In yet another embodiment, the channel sample information may be channel sample information sent by the network side. For example, the network side may share a test dataset with the terminal side, and the terminal side may extract channel sample information from the test dataset. The test dataset pre-stores actually measured CSI, such as full channel information, or feature vectors processed from the full channel information. The network side may specifically be a base station, core network, network node, etc., which is not specifically limited here. It should be noted that there may be other possible ways for the terminal side to obtain the channel state information for performance testing, which are not specifically limited here.

For the embodiments of the present disclosure, when using the channel sample information for performance testing when the encoder and decoder are jointly used to determine whether the performance requirements are met:

In an embodiment, the terminal side may compress the channel sample information; receive the first auxiliary information sent by the network side; determine, based on the first auxiliary information, decompressed information obtained by decompressing the compressed channel sample information (where the first auxiliary information may include the decoder or the decompressed information); then compare the decompressed information with the channel sample information before compression to obtain first performance test information when the encoder and decoder are jointly used; and compare the first performance test information with a preset performance requirement to determine whether the performance requirements are met when the encoder and decoder are jointly used. The specific implementation process can be referred to the detailed description of the steps in the embodiment shown in FIG. 3.

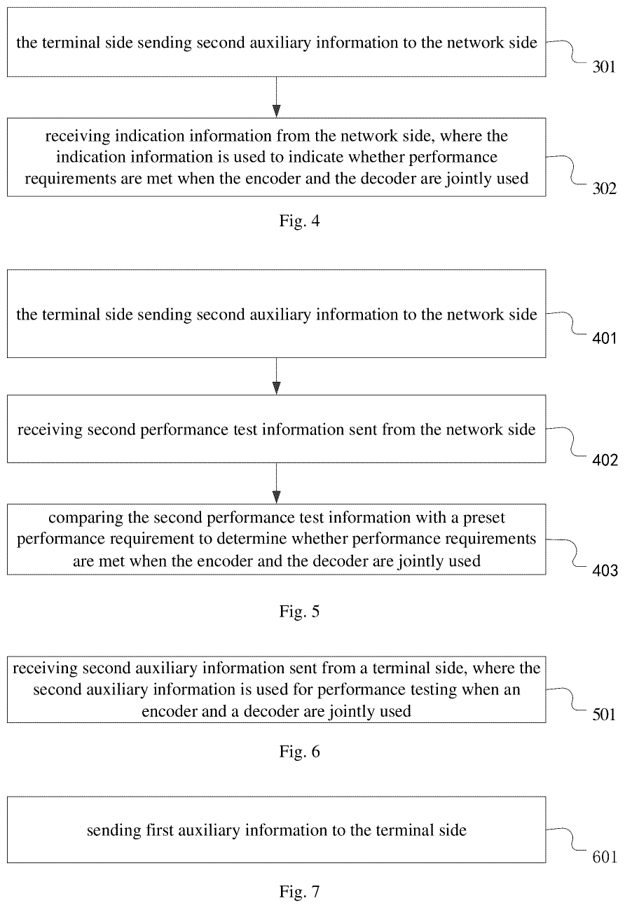

In another embodiment, the terminal side may send second auxiliary information to the network side. The second auxiliary information may include one or more of: compressed channel sample information, first performance test information when the encoder and decoder are jointly used, channel sample information before compression, a preset performance requirement, or may also include other auxiliary information, which is not specifically limited here. The terminal side may receive indication information from the network side. The indication information is sent by the network side to the terminal side after the network side determines, based on the second auxiliary information, whether the performance requirements are met when the encoder and decoder are jointly used. The indication information is used to indicate whether the performance requirements are met when the encoder and decoder are jointly used. The specific implementation process can be referred to the detailed description of the steps in the embodiment shown in FIG. 4.

In yet another embodiment, the terminal side may send second auxiliary information to the network side. The second auxiliary information may include compressed channel sample information and channel sample information before compression. The terminal side may receive second performance test information sent by the network side. The second performance test information is obtained by the network side by comparing decompressed information with channel sample information before compression based on the second auxiliary information. The terminal side compares the second performance test information with a preset performance requirement to determine whether the performance requirements are met when the encoder and decoder are jointly used. The specific implementation process can be referred to the detailed description of the steps in the embodiment shown in FIG. 5.

In summary, according to the information processing method provided by the embodiments of the present disclosure, in response to the encoder being deployed at the terminal side and the decoder being deployed at the network side, the terminal side receives first auxiliary information sent by the network side, the first auxiliary information being used for performance testing when the encoder and decoder are jointly used. By conducting performance testing when the encoder and decoder are jointly used before formally deploying and applying them, and only by the encoder and decoder to transmit channel state information if it is determined that performance requirements are met, thereby ensuring accurate and efficient feedback of channel state information.

FIG. 3 shows a schematic flowchart of a method for processing information according to an embodiment of the present disclosure. As shown in FIG. 3, the method is applied to the terminal side and may include the following steps.

Step 201: compressing channel sample information by the encoder, where the channel sample information is channel state information used for performance testing.

The channel sample information is predefined channel state information, or, the channel sample information is channel sample information sent by the network side. For the method of obtaining the channel sample information, refer to the detailed description of the steps in the embodiment shown in FIG. 2, which will not be repeated here. For the embodiments of the present disclosure, after obtaining the channel sample information, the terminal side compresses the channel sample information using the locally deployed encoder.

Step 202: receiving first auxiliary information sent by the network side, and determine decompressed information obtained by decompressing the compressed channel sample information based on the first auxiliary information.

The first auxiliary information may include a decoder deployed at the network side and used for decompression processing, or may also include decompressed information obtained by the network side decompressing the compressed channel sample information using the locally deployed decoder. When the first auxiliary information is the decompressed information, before executing this step, the terminal side, after obtaining the compressed channel sample information in step 201, also needs to send the compressed channel sample information to the network side so that the network side can perform decompression processing on the compressed channel sample information.

For the embodiments of the present disclosure, as one possible implementation, the terminal side receives the decoder deployed at the network side contained in the first auxiliary information sent by the network side. The terminal side can use the decoder sent by the network side to decompress the compressed channel sample information to obtain decompressed information. In another embodiment, the terminal side receives decompressed information contained in the first auxiliary information sent by the network side. The decompressed information is information obtained by the network side decompressing the compressed channel sample information using the decoder.

Step 203: comparing the decompressed information with the channel sample information before compression to obtain first performance test information when the encoder and decoder are jointly used; compare the first performance test information with a preset performance requirement to determine whether performance requirements are met when the encoder and decoder are jointly used.

The first performance test information is an information difference value determined by the terminal side by comparing the decompressed information with the channel sample information before compression. The information difference value reflects the connection performance when the encoder and decoder are jointly used. A large information difference value indicates poor connection performance when the encoder and decoder are jointly used, making it unsuitable for accurately transmitting channel state information; a small information difference value indicates that the connection performance when the encoder and decoder are jointly used can meet the performance requirements for channel state information transmission and can be used for accurate transmission of channel state information.

For the embodiments of the present disclosure, after determining the first performance test information when the encoder and decoder are jointly used, the terminal may compare the first performance test information with the preset performance requirement and determine whether the performance requirements are met when the encoder and decoder are jointly used based on the comparison result; or it may send the first performance test information to the network side so that the network side compares the first performance test information with the preset performance requirement and determines whether the performance requirements are met when the encoder and decoder are jointly used based on the comparison result. The preset performance requirement may include at least one of: a preset value; a performance corresponding to a Type II CSI rule; a performance corresponding to an eType II CSI rule; a network-side defined value; or a terminal-side defined value. It should be noted that the preset performance requirement may also include other information used to compare with the first or second performance test information to determine whether the performance requirements are met when the encoder and decoder are jointly used, which is not specifically limited here.

When the terminal side compares the first performance test information with the preset performance requirement to determine whether the performance requirements are met when the encoder and decoder are jointly used:

In an embodiment, the terminal side may determine a preset value for comparison with the first performance test information. This preset value may be custom-defined by the terminal side or a fixed value agreed upon with the network side based on a protocol, which is not specifically limited here. Then, the terminal side compares the first performance test information (the information difference value between the decompressed information and the channel sample information before compression) with the preset value. If the information difference value is greater than the preset value, it indicates a large difference, meaning poor connection performance when the encoder and decoder are jointly used, and it cannot be used for accurate transmission of channel state information. If the information difference value is less than or equal to the preset value, it indicates a small difference, meaning good connection performance when the encoder and decoder are jointly used, and it can be used for accurate transmission of channel state information. It should be noted that the preset value can be set numerically according to the actual application scenario, which is not specifically limited here.

In another embodiment, the terminal side may determine the performance corresponding to the Type II CSI rule for comparison with the first performance test information. The performance corresponding to the Type II CSI rule may be the information difference value between the channel state information corresponding to the channel sample information generated by the terminal side using the traditional Type I codebook method and the channel sample information itself. The terminal side compares the first performance test information (the first information difference value between the decompressed information and the channel sample information before compression) with the second information difference value corresponding to the result generated by the traditional Type I codebook method. If the first information difference value is greater than or equal to the second information difference value, it indicates that the connection performance when the encoder and decoder are jointly used is worse than or the same as the traditional method, and cannot be used for accurate transmission of channel state information. If the first information difference value is less than the second information difference value, it indicates that the connection performance when the encoder and decoder are jointly used is better than the traditional method and can be used for accurate transmission of channel state information.

In another embodiment, the terminal side may determine the performance corresponding to the eType II CSI rule for comparison with the first performance test information. The performance corresponding to the eType II CSI rule may be the information difference value between the channel state information corresponding to the channel sample information generated by the terminal side using the traditional eType II codebook method and the channel sample information itself. The terminal side compares the first performance test information (the first information difference value between the decompressed information and the channel sample information before compression) with the third information difference value corresponding to the result generated by the traditional eType II codebook method. If the first information difference value is greater than or equal to the third information difference value, it indicates that the connection performance when the encoder and decoder are jointly used is worse than or the same as the traditional method, and cannot be used for accurate transmission of channel state information. If the first information difference value is less than the third information difference value, it indicates that the connection performance when the encoder and decoder are jointly used is better than the traditional method and can be used for accurate transmission of channel state information.

In another embodiment, the terminal side receives a network-side defined value sent by the network side for comparison with the first performance test information. Then, the terminal side compares the first performance test information (the information difference value between the decompressed information and the channel sample information before compression) with the network-side defined value. If the information difference value is greater than the network-side defined value, it indicates a large difference, meaning poor connection performance when the encoder and decoder are jointly used, and it cannot be used for accurate transmission of channel state information. If the information difference value is less than or equal to the network-side defined value, it indicates a small difference, meaning good connection performance when the encoder and decoder are jointly used, and it can be used for accurate transmission of channel state information. It should be noted that the network-side defined value can be set numerically according to the actual application scenario, which is not specifically limited here.

In another embodiment, the terminal side may obtain a terminal-side defined value defined by itself for comparison with the first performance test information. Then, the terminal side compares the first performance test information (the information difference value between the decompressed information and the channel sample information before compression) with the terminal-side defined value. If the information difference value is greater than the terminal-side defined value, it indicates a large difference, meaning poor connection performance when the encoder and decoder are jointly used, and it cannot be used for accurate transmission of channel state information. If the information difference value is less than or equal to the terminal-side defined value, it indicates a small difference, meaning good connection performance when the encoder and decoder are jointly used, and it can be used for accurate transmission of channel state information. It should be noted that the terminal-side defined value can be set numerically according to the actual application scenario, which is not specifically limited here.

It should be noted that the above possible implementations can be used alone or in combination to determine whether the performance requirements are met when the encoder and decoder are jointly used, which is not specifically limited here.

For the embodiments of the present disclosure, if it is determined that the performance requirements are met when the encoder and decoder are jointly used, the encoder and decoder can be used to transmit channel state information. If it is determined that the performance requirements are not met, the encoder can be retrained so that the performance requirements are met when used jointly with the decoder.

In an embodiment, after determining whether the performance requirements are met when the encoder and decoder are jointly used based on the first auxiliary information, the terminal side may also send indication information to the network side. The indication information is used to notify the network side whether the performance requirements are met when the encoder and decoder are jointly used.

In summary, according to the information processing method provided by the embodiments of the present disclosure, in response to the encoder being deployed at the terminal side and the decoder being deployed at the network side, the terminal side can conduct performance testing when the encoder and decoder are jointly used before formally deploying and applying them. Only when the performance requirements are met are the encoder and decoder used to transmit channel state information, thereby ensuring accurate and efficient feedback of channel state information.

FIG. 4 shows a schematic flowchart of a method for processing information according to an embodiment of the present disclosure. As shown in FIG. 4, the method is applied to the terminal side and may include the following steps.

Step 301: the terminal side sending second auxiliary information to the network side.

For the embodiments of the present disclosure, the second auxiliary information may include one or more of: compressed channel sample information, first performance test information, channel sample information before compression, a preset performance requirement. Additionally, the second auxiliary information may include other information used by the network side to determine whether performance requirements are met when the encoder and decoder are jointly used, which is not specifically limited here. The first performance test information is obtained by the terminal side comparing the decompressed information with the channel sample information before compression. For details, refer to the relevant description in embodiment step 203, which will not be repeated here. The preset performance requirement sent by the terminal side to the network side in this step may include: a preset value, a performance corresponding to a Type II CSI rule, a performance corresponding to an eType II CSI rule, a terminal-side defined value. Additionally, the network side may locally contain preset performance requirements: a network-side defined value. It should be noted that the preset performance requirement may also include other information used to compare with the first or second performance test information to determine whether the performance requirements are met when the encoder and decoder are jointly used, which is not specifically limited here.

Step 302: receiving indication information from the network side, where the indication information is used to indicate whether performance requirements are met when the encoder and the decoder are jointly used.

The indication information is sent by the network side to the terminal side after the network side determines, based on the second auxiliary information, whether the performance requirements are met when the encoder and decoder are jointly used.

In specific application scenarios, the network side determines whether the performance requirements are met when the encoder and decoder are jointly used based on the second auxiliary information:

In an embodiment, the second auxiliary information sent by the terminal side to the network side may include compressed channel sample information, channel sample information before compression, and a preset performance requirement. The network side may use the decoder to decompress the compressed channel sample information to obtain decompressed information. Then, it can compare the decompressed information with the channel sample information before compression to obtain second performance test information when the encoder and decoder are jointly used. It compares the second performance test information with the preset performance requirement to determine whether the performance requirements are met when the encoder and decoder are jointly used.

In another embodiment, the second auxiliary information sent by the terminal side to the network side may include the first performance test information and the preset performance requirement. The network side may compare the first performance test information with the preset performance requirement to determine whether the performance requirements are met when the encoder and decoder are jointly used.

For the embodiments of the present disclosure, after determining whether the performance requirements are met when the encoder and decoder are jointly used, the network side sends indication information to the terminal side indicating whether the connection performance can be used for accurate transmission of channel state information when the encoder and decoder are jointly used. If the indication information indicates that the performance requirements are met, the terminal side can use the encoder and decoder to transmit channel state information. If the indication information indicates that the performance requirements are not met, the terminal side can retrain the encoder so that the performance requirements are met when used jointly with the decoder.

In summary, according to the information processing method provided by the embodiments of the present disclosure, in response to the encoder being deployed at the terminal side and the decoder being deployed at the network side, the network side can conduct performance testing when the encoder and decoder are jointly used before formally deploying and applying them. Only when the performance requirements are met are the encoder and decoder used to transmit channel state information, thereby ensuring accurate and efficient feedback of channel state information.

FIG. 5 shows a schematic flowchart of a method for processing information according to an embodiment of the present disclosure. As shown in FIG. 5, the method is applied to the terminal side and may include the following steps.

Step 401: the terminal side sending second auxiliary information to the network side.

For the embodiments of the present disclosure, the second auxiliary information may include compressed channel sample information and channel sample information before compression.

Step 402: receiving second performance test information sent by the network side.

The second performance test information is obtained by the network side by comparing decompressed information with channel sample information before compression based on the second auxiliary information. The second performance test information is an information difference value determined by the network side by comparing the decompressed information with the channel sample information before compression. The information difference value reflects the connection performance when the encoder and decoder are jointly used. A large information difference value indicates poor connection performance when the encoder and decoder are jointly used, making it unsuitable for accurately transmitting channel state information; a small information difference value indicates that the connection performance when the encoder and decoder are jointly used can meet the performance requirements for channel state information transmission and can be used for accurate transmission of channel state information.

Step 403: comparing the second performance test information with a preset performance requirement to determine whether performance requirements are met when the encoder and the decoder are jointly used.

For the embodiments of the present disclosure, after receiving the second performance test information sent by the network side, the terminal side compares the second performance test information with the preset performance requirement and determines whether the performance requirements are met when the encoder and decoder are jointly used based on the comparison result. The preset performance requirement may include at least one of: a preset value; a performance corresponding to a Type II CSI rule; a performance corresponding to an eType II CSI rule; a network-side defined value; or a terminal-side defined value.

When the terminal side compares the second performance test information with the preset performance requirement to determine whether the performance requirements are met when the encoder and decoder are jointly used:

In an embodiment, the terminal side may determine a preset value for comparison with the second performance test information. This preset value may be custom-defined by the terminal side or a fixed value agreed upon with the network side based on a protocol, which is not specifically limited here. Then, the terminal side compares the second performance test information (the information difference value between the decompressed information and the channel sample information before compression) with the preset value. If the information difference value is greater than the preset value, it indicates a large difference, meaning poor connection performance when the encoder and decoder are jointly used, and it cannot be used for accurate transmission of channel state information. If the information difference value is less than or equal to the preset value, it indicates a small difference, meaning good connection performance when the encoder and decoder are jointly used, and it can be used for accurate transmission of channel state information. It should be noted that the preset value can be set numerically according to the actual application scenario, which is not specifically limited here.

In another embodiment, the terminal side may determine the performance corresponding to the Type II CSI rule for comparison with the second performance test information. The performance corresponding to the Type II CSI rule may be the information difference value between the channel state information corresponding to the channel sample information generated by the terminal side using the traditional Type I codebook method and the channel sample information itself. The terminal side compares the second performance test information (the first information difference value between the decompressed information and the channel sample information before compression) with the second information difference value corresponding to the result generated by the traditional Type I codebook method. If the first information difference value is greater than or equal to the second information difference value, it indicates that the connection performance when the encoder and decoder are jointly used is worse than or the same as the traditional method, and cannot be used for accurate transmission of channel state information. If the first information difference value is less than the second information difference value, it indicates that the connection performance when the encoder and decoder are jointly used is better than the traditional method and can be used for accurate transmission of channel state information.

In another embodiment, the terminal side may determine the performance corresponding to the eType II CSI rule for comparison with the second performance test information. The performance corresponding to the eType II CSI rule may be the information difference value between the channel state information corresponding to the channel sample information generated by the terminal side using the traditional eType II codebook method and the channel sample information itself. The terminal side compares the second performance test information (the first information difference value between the decompressed information and the channel sample information before compression) with the third information difference value corresponding to the result generated by the traditional eType II codebook method. If the first information difference value is greater than or equal to the third information difference value, it indicates that the connection performance when the encoder and decoder are jointly used is worse than or the same as the traditional method, and cannot be used for accurate transmission of channel state information. If the first information difference value is less than the third information difference value, it indicates that the connection performance when the encoder and decoder are jointly used is better than the traditional method and can be used for accurate transmission of channel state information.

In another embodiment, the terminal side receives a network-side defined value sent by the network side for comparison with the second performance test information. Then, the terminal side compares the second performance test information (the information difference value between the decompressed information and the channel sample information before compression) with the network-side defined value. If the information difference value is greater than the network-side defined value, it indicates a large difference, meaning poor connection performance when the encoder and decoder are jointly used, and it cannot be used for accurate transmission of channel state information. If the information difference value is less than or equal to the network-side defined value, it indicates a small difference, meaning good connection performance when the encoder and decoder are jointly used, and it can be used for accurate transmission of channel state information. It should be noted that the network-side defined value can be set numerically according to the actual application scenario, which is not specifically limited here.

In another embodiment, the terminal side may define a terminal-side defined value itself for comparison with the second performance test information. Then, the terminal side compares the second performance test information (the information difference value between the decompressed information and the channel sample information before compression) with the terminal-side defined value. If the information difference value is greater than the terminal-side defined value, it indicates a large difference, meaning poor connection performance when the encoder and decoder are jointly used, and it cannot be used for accurate transmission of channel state information. If the information difference value is less than or equal to the terminal-side defined value, it indicates a small difference, meaning good connection performance when the encoder and decoder are jointly used, and it can be used for accurate transmission of channel state information. It should be noted that the terminal-side defined value can be set numerically according to the actual application scenario, which is not specifically limited here.

It should be noted that the above possible implementations can be used alone or in combination to determine whether the performance requirements are met when the encoder and decoder are jointly used, which is not specifically limited here.

For the embodiments of the present disclosure, if it is determined that the performance requirements are met when the encoder and decoder are jointly used, the encoder and decoder can be used to transmit channel state information. If it is determined that the performance requirements are not met, the encoder can be retrained so that the performance requirements are met when used jointly with the decoder.

In an embodiment, after determining whether the performance requirements are met when the encoder and decoder are jointly used based on the second performance test information, the terminal side may also send indication information to the network side. The indication information is used to notify the network side whether the performance requirements are met when the encoder and decoder are jointly used.

In summary, according to the information processing method provided by the embodiments of the present disclosure, in response to the encoder being deployed at the terminal side and the decoder being deployed at the network side, the terminal side and the network side can jointly conduct performance testing when the encoder and decoder are jointly used before formally deploying and applying them. Only when the performance requirements are met are the encoder and decoder used to transmit channel state information, thereby ensuring accurate and efficient feedback of channel state information.

FIG. 6 shows a schematic flowchart of a method for processing information according to an embodiment of the present disclosure. As shown in FIG. 6, the method is applied to the network side. The network side may specifically be a base station, core network, network node, etc., which is not specifically limited here. The method may include the following steps.

Step 501: receiving second auxiliary information sent by a terminal side, where the second auxiliary information is used for performance testing when an encoder and a decoder are jointly used.

The encoder is deployed at a terminal side and used to compress channel state information; and the decoder is deployed at the network side and used to decompress the channel state information compressed by the encoder. The second auxiliary information is used by the network side to determine second performance test information when the encoder and decoder are jointly used, or to determine whether the performance requirements are met when the encoder and decoder are jointly used. It may include compressed channel sample information, first performance test information when the encoder and decoder are jointly used, channel sample information before compression, a preset performance requirement, etc., which is not specifically limited here. In specific application scenarios, the network side may send a second auxiliary performance test request to the terminal side, where the second auxiliary performance test request is used by the terminal side to send the first auxiliary information.

For the embodiments of the present disclosure, the channel sample information is channel state information obtained by the terminal side based on the first auxiliary information sent by the network side for performance testing. Before executing this step, the network side needs to send the first auxiliary information to the terminal side. The first auxiliary information may include a reference signal for measuring channel sample information, and a decoder and decompressed information for decompression processing, or may also include other information, which is not specifically limited here. When the terminal side obtains the channel sample information, as one possible implementation, the network side may, in response to a first auxiliary performance test request sent by the terminal side, send a reference signal for channel state information measurement to the terminal side, so that the terminal side can obtain the channel sample information by measuring the reference signal. The reference signal may be, for example, a Channel-State-Information Reference Signal (CSI-RS), which is not specifically limited here. In another embodiment, the channel sample information may also be predefined channel state information. For example, the terminal side may obtain an offline test dataset and extract channel sample information from the test dataset. The test dataset pre-stores CSI actually measured by the terminal, such as full channel information, or feature vectors processed from the full channel information. Additionally, as another possible implementation, the channel sample information may be channel sample information sent by the network side. For example, the network side may also send a shared test dataset to the terminal side so that the terminal side can extract channel sample information from the test dataset. The test dataset pre-stores CSI actually measured by the terminal, such as full channel information, or feature vectors processed from the full channel information, which is not specifically limited here.

For the embodiments of the present disclosure, the network side can conduct performance testing when the encoder and decoder are jointly used based on the second auxiliary information sent by the terminal side, and determine whether the performance requirements are met when the encoder and decoder are jointly used:

In an embodiment, the network side may send first auxiliary information to the terminal side, enabling the terminal side to determine decompressed information obtained by decompressing the compressed channel sample information based on the first auxiliary information, compare the decompressed information with the channel sample information before compression to obtain first performance test information when the encoder and decoder are jointly used; and the terminal side compares the first performance test information with a preset performance requirement to determine whether the performance requirements are met when the encoder and decoder are jointly used. In this case, the first auxiliary information sent by the network side to the terminal side may include a decoder for decompression processing and decompressed information; optionally, the network side may also receive indication information sent by the terminal side. The indication information is sent by the terminal side to the network side after the terminal side determines, based on the first auxiliary information, whether the performance requirements are met when the encoder and decoder are jointly used. The indication information is used to indicate whether the performance requirements are met when the encoder and decoder are jointly used. The specific implementation process can be referred to the detailed description of the steps in the embodiment shown in FIG. 7.

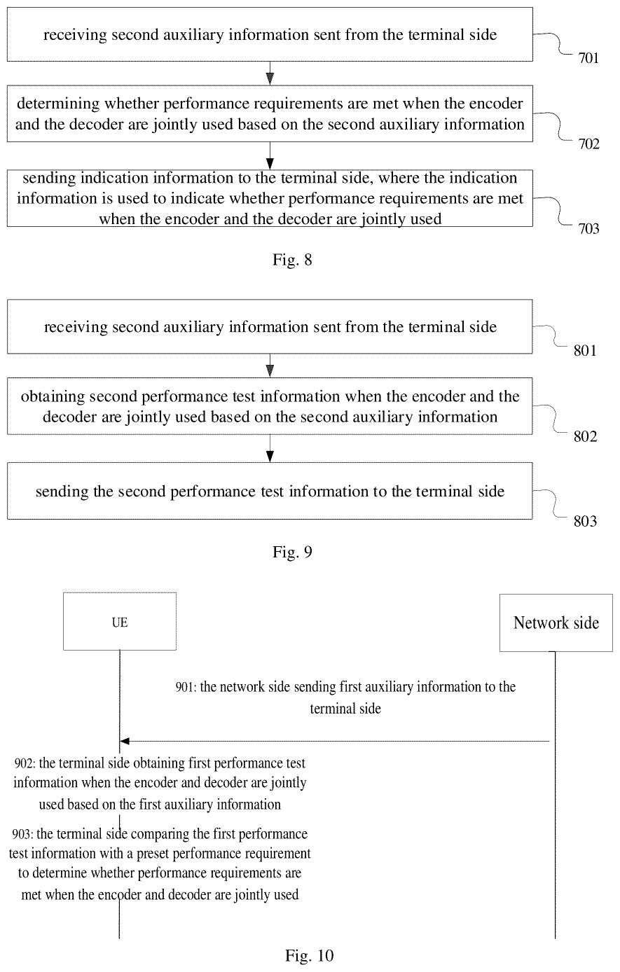

In another embodiment, the network side receives the second auxiliary information sent by the terminal side. The second auxiliary information may include compressed channel sample information, first performance test information when the encoder and decoder are jointly used, channel sample information before compression, a preset performance requirement, etc., which is not specifically limited here. The network side may determine whether the performance requirements are met when the encoder and decoder are jointly used based on the second auxiliary information; send indication information to the terminal side, where the indication information is used to indicate whether the performance requirements are met when the encoder and decoder are jointly used. The specific implementation process can be referred to the detailed description of the steps in the embodiment shown in FIG. 8.

In yet another embodiment, the network side receives the second auxiliary information sent by the terminal side. In this case, the second auxiliary information may include compressed channel sample information and channel sample information before compression. The network side may obtain second performance test information when the encoder and decoder are jointly used based on the second auxiliary information; send the second performance test information to the terminal side; optionally, the network side may also receive indication information sent by the terminal side. The indication information is sent by the terminal side to the network side after the terminal side determines, based on the second performance test information, whether the performance requirements are met when the encoder and decoder are jointly used. The indication information is used to indicate whether the performance requirements are met when the encoder and decoder are jointly used. The specific implementation process can be referred to the detailed description of the steps in the embodiment shown in FIG. 9.

In summary, according to the information processing method provided by the embodiments of the present disclosure, in response to the encoder being deployed at the terminal side and the decoder being deployed at the network side, the network side receives second auxiliary information sent by the terminal side, the second auxiliary information being used for performance testing when the encoder and decoder are jointly used. By conducting performance testing when the encoder and decoder are jointly used before formally deploying and applying them, and only by the encoder and decoder to transmit channel state information if it is determined that performance requirements are met, thereby ensuring accurate and efficient feedback of channel state information.

FIG. 7 shows a schematic flowchart of a method for processing information according to an embodiment of the present disclosure. As shown in FIG. 7, the method is applied to the network side and may include the following steps.

Step 601: sending first auxiliary information to the terminal side.

The first auxiliary information sent by the network side to the terminal side may include a decoder for decompression processing and decompressed information. The network side sending the first auxiliary information to the terminal side enables the terminal side to determine the decompressed information based on the decoder in the first auxiliary information, or to directly receive the decompressed information sent by the network side.

For the embodiments of the present disclosure, as one possible implementation, the first auxiliary information sent by the network side to the terminal side contains the decoder deployed at the network side. The terminal side can use the decoder sent by the network side to decompress the compressed channel sample information to obtain decompressed information. In another embodiment, the first auxiliary information sent by the network side to the terminal side may contain decompressed information. The decompressed information is information obtained by the network side decompressing the compressed channel sample information using the decoder. When the first auxiliary information is the decompressed information, before executing this step, the network side may also receive compressed channel sample information sent by the terminal side. The network side decompresses the compressed channel sample information to obtain the decompressed information.

Optionally, the network side may also receive indication information sent by the terminal side. The indication information is sent by the terminal side to the network side after the terminal side determines, based on the first auxiliary information, whether the performance requirements are met when the encoder and decoder are jointly used. The indication information is used to indicate whether the performance requirements are met when the encoder and decoder are jointly used. The terminal side determining whether the performance requirements are met when the encoder and decoder are jointly used based on the first auxiliary information can be referred to the relevant description in embodiment steps 202 and 203, which will not be repeated here.

In summary, according to the information processing method provided by the embodiments of the present disclosure, in response to the encoder being deployed at the terminal side and the decoder being deployed at the network side, the network side can send first auxiliary information to the terminal side before formally deploying and applying the encoder and decoder, enabling the terminal side to conduct performance testing when the encoder and decoder are jointly used based on the first auxiliary information. Only when the performance requirements are met are the encoder and decoder used to transmit channel state information, thereby ensuring accurate and efficient feedback of channel state information.

FIG. 8 shows a schematic flowchart of a method for processing information according to an embodiment of the present disclosure. As shown in FIG. 8, the method is applied to the network side and may include the following steps.

Step 701: receiving second auxiliary information sent by the terminal side.

For the embodiments of the present disclosure, the second auxiliary information may include one or more of: compressed channel sample information, first performance test information when the encoder and decoder are jointly used, channel sample information before compression, a preset performance requirement. Additionally, the second auxiliary information may include other information used by the network side to determine whether performance requirements are met when the encoder and decoder are jointly used, which is not specifically limited here. The first performance test information is obtained by the terminal side comparing the decompressed information with the channel sample information before compression. For details, refer to the relevant description in embodiment step 203, which will not be repeated here. The preset performance requirement received by the network side from the terminal side in this step may include: a preset value, a performance corresponding to a Type II CSI rule, a performance corresponding to an eType II CSI rule, a terminal-side defined value. Additionally, the network side may locally contain preset performance requirements: a network-side defined value. It should be noted that the preset performance requirement may also include other information used to compare with the first or second performance test information to determine whether the performance requirements are met when the encoder and decoder are jointly used, which is not specifically limited here.

Step 702: determining whether performance requirements are met when the encoder and the decoder are jointly used based on the second auxiliary information.

For the embodiments of the present disclosure, the network side determines whether the performance requirements are met when the encoder and decoder are jointly used based on the second auxiliary information:

In an embodiment, the second auxiliary information sent by the terminal side to the network side may include compressed channel sample information, channel sample information before compression, and a preset performance requirement. The network side may use the decoder to decompress the compressed channel sample information to obtain decompressed information. Then, the network side can compare the decompressed information with the channel sample information before compression to obtain second performance test information when the encoder and decoder are jointly used; compare the second performance test information with the preset performance requirement to determine whether the performance requirements are met when the encoder and decoder are jointly used; or the network side may also send the second performance test information to the terminal side, enabling the terminal side to compare the second performance test information with the preset performance requirement and determine whether the performance requirements are met when the encoder and decoder are jointly used.

In another embodiment, the second auxiliary information sent by the terminal side to the network side may include the first performance test information and the preset performance requirement. The network side may compare the first performance test information with the preset performance requirement to determine whether the performance requirements are met when the encoder and decoder are jointly used.

The preset performance requirement may include at least one of: a preset value; a performance corresponding to a Type II CSI rule; a performance corresponding to an eType II CSI rule; a network-side defined value; or a terminal-side defined value. It should be noted that the preset performance requirement may also include other information used to compare with the first or second performance test information to determine whether the performance requirements are met when the encoder and decoder are jointly used, which is not specifically limited here.

Correspondingly, when the network side compares the first performance test information with the preset performance requirement to determine whether the performance requirements are met when the encoder and decoder are jointly used:

In an embodiment, the network side may determine a preset value for comparison with the first performance test information. This preset value may be custom-defined by the network side or a fixed value agreed upon with the terminal side based on a protocol, which is not specifically limited here. Then, the network side compares the first performance test information (the information difference value between the decompressed information and the channel sample information before compression) with the preset value. If the information difference value is greater than the preset value, it indicates a large difference, meaning poor connection performance when the encoder and decoder are jointly used, and it cannot be used for accurate transmission of channel state information. If the information difference value is less than or equal to the preset value, it indicates a small difference, meaning good connection performance when the encoder and decoder are jointly used, and it can be used for accurate transmission of channel state information. It should be noted that the preset value can be set numerically according to the actual application scenario, which is not specifically limited here.

In another embodiment, the network side may receive the performance corresponding to the Type II CSI rule sent by the terminal side for comparison with the first performance test information. The performance corresponding to the Type II CSI rule may be the information difference value between the channel state information corresponding to the channel sample information generated by the terminal side using the traditional Type I codebook method and the channel sample information itself. The network side compares the first performance test information (the first information difference value between the decompressed information and the channel sample information before compression) with the second information difference value corresponding to the result generated by the traditional Type I codebook method. If the first information difference value is greater than or equal to the second information difference value, it indicates that the connection performance when the encoder and decoder are jointly used is worse than or the same as the traditional method, and cannot be used for accurate transmission of channel state information. If the first information difference value is less than the second information difference value, it indicates that the connection performance when the encoder and decoder are jointly used is better than the traditional method and can be used for accurate transmission of channel state information.

In another embodiment, the network side may receive the performance corresponding to the eType II CSI rule sent by the terminal side for comparison with the first performance test information. The performance corresponding to the eType II CSI rule may be the information difference value between the channel state information corresponding to the channel sample information generated by the terminal side using the traditional eType II codebook method and the channel sample information itself. The network side compares the first performance test information (the first information difference value between the decompressed information and the channel sample information before compression) with the third information difference value corresponding to the result generated by the traditional eType II codebook method. If the first information difference value is greater than or equal to the third information difference value, it indicates that the connection performance when the encoder and decoder are jointly used is worse than or the same as the traditional method, and cannot be used for accurate transmission of channel state information. If the first information difference value is less than the third information difference value, it indicates that the connection performance when the encoder and decoder are jointly used is better than the traditional method and can be used for accurate transmission of channel state information.

In another embodiment, the network side may obtain a network-side defined value defined by itself for comparison with the first performance test information. Then, the network side compares the first performance test information (the information difference value between the decompressed information and the channel sample information before compression) with the network-side defined value. If the information difference value is greater than the network-side defined value, it indicates a large difference, meaning poor connection performance when the encoder and decoder are jointly used, and it cannot be used for accurate transmission of channel state information. If the information difference value is less than or equal to the network-side defined value, it indicates a small difference, meaning good connection performance when the encoder and decoder are jointly used, and it can be used for accurate transmission of channel state information. It should be noted that the network-side defined value can be set numerically according to the actual application scenario, which is not specifically limited here.

In another embodiment, the network side receives a terminal-side defined value defined by the terminal side for comparison with the first performance test information. Then, the network side compares the first performance test information (the information difference value between the decompressed information and the channel sample information before compression) with the terminal-side defined value. If the information difference value is greater than the network-side defined value, it indicates a large difference, meaning poor connection performance when the encoder and decoder are jointly used, and it cannot be used for accurate transmission of channel state information. If the information difference value is less than or equal to the terminal-side defined value, it indicates a small difference, meaning good connection performance when the encoder and decoder are jointly used, and it can be used for accurate transmission of channel state information. It should be noted that the terminal-side defined value can be set numerically according to the actual application scenario, which is not specifically limited here.

It should be noted that the above possible implementations can be used alone or in combination to determine whether the performance requirements are met when the encoder and decoder are jointly used, which is not specifically limited here.

Correspondingly, when the network side compares the second performance test information with the preset performance requirement to determine whether the performance requirements are met when the encoder and decoder are jointly used:

In an embodiment, the network side may determine a preset value for comparison with the second performance test information. This preset value may be custom-defined by the network side or a fixed value agreed upon with the terminal side based on a protocol, which is not specifically limited here. Then, the network side compares the second performance test information (the information difference value between the decompressed information and the channel sample information before compression) with the preset value. If the information difference value is greater than the preset value, it indicates a large difference, meaning poor connection performance when the encoder and decoder are jointly used, and it cannot be used for accurate transmission of channel state information. If the information difference value is less than or equal to the preset value, it indicates a small difference, meaning good connection performance when the encoder and decoder are jointly used, and it can be used for accurate transmission of channel state information. It should be noted that the preset value can be set numerically according to the actual application scenario, which is not specifically limited here.

In another embodiment, the network side may receive the performance corresponding to the Type II CSI rule sent by the terminal side for comparison with the second performance test information. The performance corresponding to the Type II CSI rule may be the information difference value between the channel state information corresponding to the channel sample information generated by the terminal side using the traditional Type I codebook method and the channel sample information itself. The network side compares the second performance test information (the first information difference value between the decompressed information and the channel sample information before compression) with the second information difference value corresponding to the result generated by the traditional Type I codebook method. If the first information difference value is greater than or equal to the second information difference value, it indicates that the connection performance when the encoder and decoder are jointly used is worse than or the same as the traditional method, and cannot be used for accurate transmission of channel state information. If the first information difference value is less than the second information difference value, it indicates that the connection performance when the encoder and decoder are jointly used is better than the traditional method and can be used for accurate transmission of channel state information.

In another embodiment, the network side may receive the performance corresponding to the eType II CSI rule sent by the terminal side for comparison with the second performance test information. The performance corresponding to the eType II CSI rule may be the information difference value between the channel state information corresponding to the channel sample information generated by the terminal side using the traditional eType II codebook method and the channel sample information itself. The network side compares the second performance test information (the first information difference value between the decompressed information and the channel sample information before compression) with the third information difference value corresponding to the result generated by the traditional eType II codebook method. If the first information difference value is greater than or equal to the third information difference value, it indicates that the connection performance when the encoder and decoder are jointly used is worse than or the same as the traditional method, and cannot be used for accurate transmission of channel state information. If the first information difference value is less than the third information difference value, it indicates that the connection performance when the encoder and decoder are jointly used is better than the traditional method and can be used for accurate transmission of channel state information.

In another embodiment, the network side may obtain a network-side defined value defined by itself for comparison with the second performance test information. Then, the network side compares the second performance test information (the information difference value between the decompressed information and the channel sample information before compression) with the network-side defined value. If the information difference value is greater than the network-side defined value, it indicates a large difference, meaning poor connection performance when the encoder and decoder are jointly used, and it cannot be used for accurate transmission of channel state information. If the information difference value is less than or equal to the network-side defined value, it indicates a small difference, meaning good connection performance when the encoder and decoder are jointly used, and it can be used for accurate transmission of channel state information. It should be noted that the network-side defined value can be set numerically according to the actual application scenario, which is not specifically limited here.

In another embodiment, the network side receives a network-side defined value defined by the terminal side for comparison with the second performance test information. Then, the network side compares the second performance test information (the information difference value between the decompressed information and the channel sample information before compression) with the network-side defined value. If the information difference value is greater than the network-side defined value, it indicates a large difference, meaning poor connection performance when the encoder and decoder are jointly used, and it cannot be used for accurate transmission of channel state information. If the information difference value is less than or equal to the network-side defined value, it indicates a small difference, meaning good connection performance when the encoder and decoder are jointly used, and it can be used for accurate transmission of channel state information. It should be noted that the network-side defined value can be set numerically according to the actual application scenario, which is not specifically limited here.

It should be noted that the above possible implementations can be used alone or in combination to determine whether the performance requirements are met when the encoder and decoder are jointly used, which is not specifically limited here.

Step 703: sending indication information to the terminal side, where the indication information is used to indicate whether performance requirements are met when the encoder and the decoder are jointly used.

The indication information is sent by the network side to the terminal side after the network side determines, based on the second auxiliary information, whether the performance requirements are met when the encoder and decoder are jointly used.

For the embodiments of the present disclosure, after determining whether the performance requirements are met when the encoder and decoder are jointly used, the network side sends indication information to the terminal side indicating whether the connection performance can be used for accurate transmission of channel state information when the encoder and decoder are jointly used. If the indication information indicates that the performance requirements are met, the terminal side can use the encoder and decoder to transmit channel state information. If the indication information indicates that the performance requirements are not met, the terminal side can retrain the encoder so that the performance requirements are met when used jointly with the decoder.

In summary, according to the information processing method provided by the embodiments of the present disclosure, in response to the encoder being deployed at the terminal side and the decoder being deployed at the network side, the network side can conduct performance testing when the encoder and decoder are jointly used before formally deploying and applying them. Only when the performance requirements are met are the encoder and decoder used to transmit channel state information, thereby ensuring accurate and efficient feedback of channel state information.

FIG. 9 shows a schematic flowchart of a method for processing information according to an embodiment of the present disclosure. As shown in FIG. 9, the method is applied to the network side and may include the following steps.

Step 801: receiving second auxiliary information sent by the terminal side.

For the embodiments of the present disclosure, the second auxiliary information may include compressed channel sample information and channel sample information before compression.

Step 802: obtaining second performance test information when the encoder and the decoder are jointly used based on the second auxiliary information.

The second performance test information is obtained by the network side by comparing decompressed information with channel sample information before compression based on the second auxiliary information. The second performance test information is an information difference value determined by the network side by comparing the decompressed information with the channel sample information before compression. The information difference value reflects the connection performance when the encoder and decoder are jointly used. A large information difference value indicates poor connection performance when the encoder and decoder are jointly used, making it unsuitable for accurately transmitting channel state information; a small information difference value indicates that the connection performance when the encoder and decoder are jointly used can meet the performance requirements for channel state information transmission and can be used for accurate transmission of channel state information.

For the embodiments of the present disclosure, when the network side determines the second performance test information when the encoder and decoder are jointly used based on the compressed channel sample information and the channel sample information before compression, as one possible implementation, the network side may use the decoder to decompress the compressed channel sample information to obtain decompressed information. Then, it can compare the decompressed information with the channel sample information before compression to obtain the second performance test information when the encoder and decoder are jointly used.

Step 803: sending the second performance test information to the terminal side.

The second performance test information is obtained by the network side by comparing decompressed information with channel sample information before compression based on the second auxiliary information. For the embodiments of the present disclosure, by sending the second performance test information to the terminal side, the terminal side is enabled to compare the second performance test information with a preset performance requirement and determine whether the performance requirements are met when the encoder and decoder are jointly used. The specific implementation can be referred to the relevant description in embodiment step 403, which will not be repeated here.

Optionally, the network side may also receive indication information sent by the terminal side. The indication information is sent by the terminal side to the network side after the terminal side determines, based on the second performance test information, whether the performance requirements are met when the encoder and decoder are jointly used. The indication information is used to indicate whether the performance requirements are met when the encoder and decoder are jointly used.

In summary, according to the information processing method provided by the embodiments of the present disclosure, in response to the encoder being deployed at the terminal side and the decoder being deployed at the network side, the terminal side and the network side can jointly conduct performance testing when the encoder and decoder are jointly used before formally deploying and applying them. Only when the performance requirements are met are the encoder and decoder used to transmit channel state information, thereby ensuring accurate and efficient feedback of channel state information.

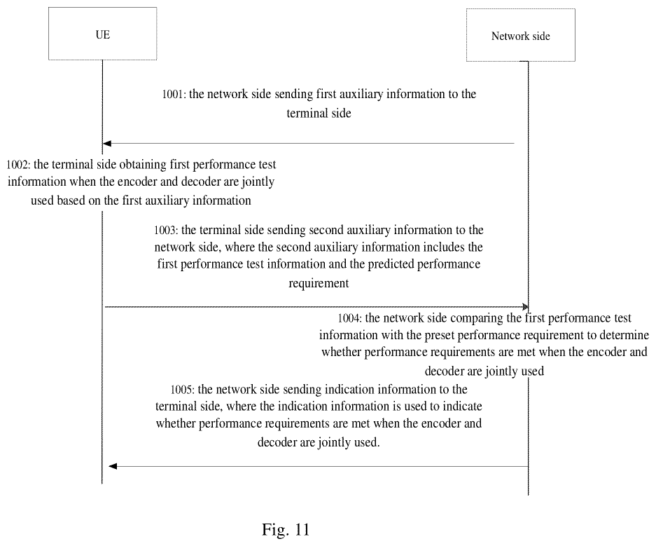

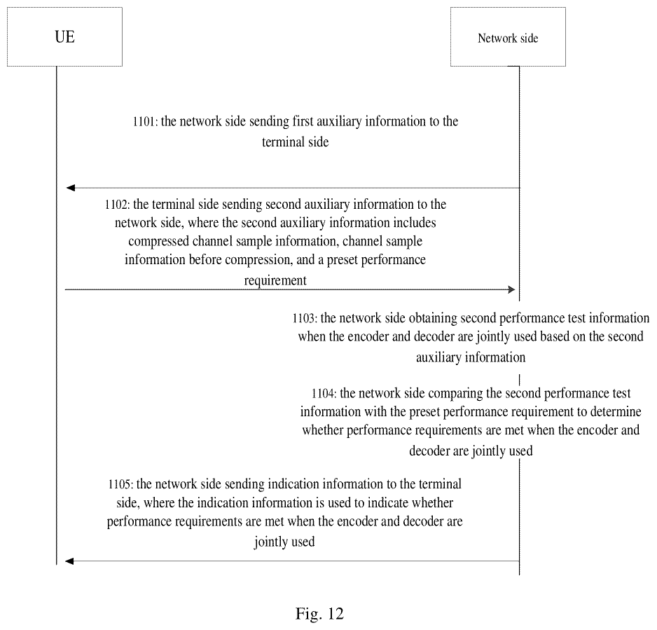

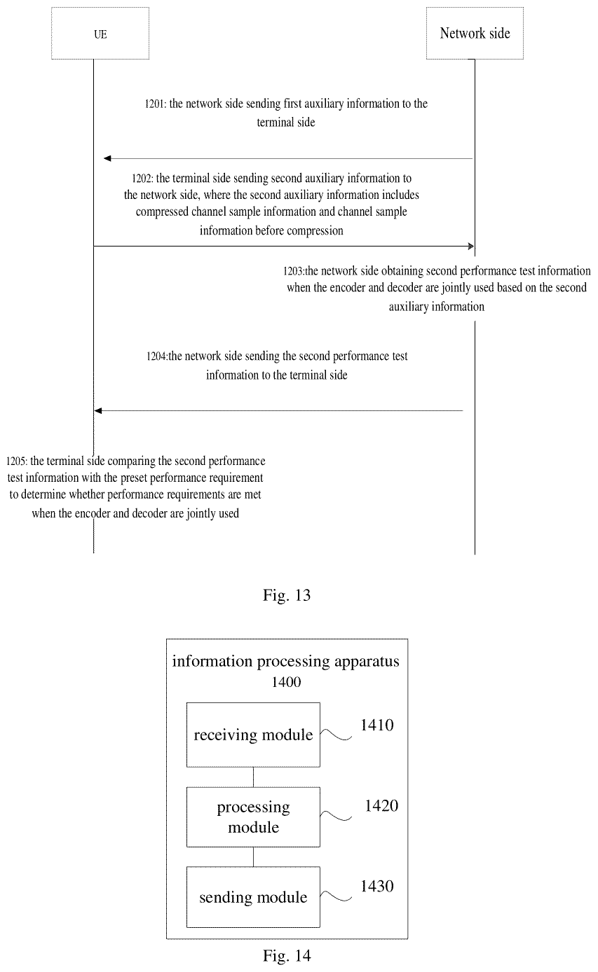

FIGS. 10, 11, 12, and 13 are sequence diagrams of a method for processing information according to an embodiment of the present disclosure. The method is applied to a communication system including a terminal device (UE) and a network side device. An encoder is deployed on the UE, and a decoder is deployed on the network side. As shown in FIG. 10, as one possible implementation, the network side sends first auxiliary information to the terminal side; the terminal side obtains first performance test information when the encoder and decoder are jointly used based on the first auxiliary information; the terminal side compares the first performance test information with a preset performance requirement to determine whether performance requirements are met when the encoder and decoder are jointly used. As shown in FIG. 11, as another possible implementation, the network side sends first auxiliary information to the terminal side; the terminal side obtains first performance test information when the encoder and decoder are jointly used based on the first auxiliary information; the terminal side sends the first performance test information to the network side; the network side compares the first performance test information with a preset performance requirement to determine whether performance requirements are met when the encoder and decoder are jointly used; the network side sends indication information to the terminal side, where the indication information is used to indicate whether performance requirements are met when the encoder and decoder are jointly used. As shown in FIG. 12, as yet another possible implementation, the terminal side sends second auxiliary information to the network side; the network side obtains second performance test information when the encoder and decoder are jointly used based on the second auxiliary information; the network side compares the second performance test information with a preset performance requirement to determine whether performance requirements are met when the encoder and decoder are jointly used; the network side sends indication information to the terminal side, where the indication information is used to indicate whether performance requirements are met when the encoder and decoder are jointly used. As shown in FIG. 13, as another possible implementation, the terminal side sends second auxiliary information to the network side; the network side obtains second performance test information when the encoder and decoder are jointly used based on the second auxiliary information; the network side sends the second performance test information to the terminal side; the terminal side compares the second performance test information with a preset performance requirement to determine whether performance requirements are met when the encoder and decoder are jointly used.

For the embodiments of the present disclosure, when determining whether performance requirements are met when the encoder and decoder are jointly used:

In an embodiment, referring to FIG. 10, the method includes the following steps:
Step 901: the network side sending first auxiliary information to the terminal side.

For the embodiments of the present disclosure, the specific implementation can be referred to the relevant description in embodiment steps 501 and 601, which will not be repeated here.

For the embodiments of the present disclosure, the terminal side first needs to determine the channel sample information used for performance testing. Then, by comparing the channel sample information with the channel sample information after compression and decompression processing, it determines the first performance test information when the encoder and decoder are jointly used. By comparing the first performance test information with a preset performance requirement, it determines whether the performance requirements are met when the encoder and decoder are jointly used.

When the terminal side obtains the channel sample information, as one possible implementation, the network side may send a reference signal for channel state information measurement to the terminal side, so that the terminal side can obtain the channel sample information by measuring the reference signal. In this case, the first auxiliary information sent by the network side to the terminal side may include the reference signal for measuring the channel sample information. In another embodiment, the channel sample information may also be predefined channel state information. For example, the terminal side may obtain an offline test dataset and extract channel sample information from the test dataset. The test dataset pre-stores CSI actually measured by the terminal, such as full channel information, or feature vectors processed from the full channel information. In this case, the first auxiliary information sent by the network side to the terminal side may not include the reference signal for measuring the channel sample information.

When the terminal side determines the decompressed information after decompression processing of the channel sample information, as one possible implementation, the network side may send a decoder for decompression processing to the terminal side. After compressing the channel sample information by the encoder, the terminal uses the received decoder to decompress the compressed channel sample information to obtain decompressed information. In this case, the first auxiliary information sent by the network side to the terminal side may also include the decoder for decompression processing. In another embodiment, the network side may send decompressed information obtained by decompressing the compressed channel sample information using the decoder to the terminal side. In this case, the first auxiliary information sent by the network side to the terminal side may also include the decompressed information.

Step 902: the terminal side obtaining first performance test information when the encoder and decoder are jointly used based on the first auxiliary information.

For the embodiments of the present disclosure, the specific implementation can be referred to the relevant description in embodiment step 203, which will not be repeated here.

Step 903: the terminal side comparing the first performance test information with a preset performance requirement to determine whether performance requirements are met when the encoder and decoder are jointly used.

For the embodiments of the present disclosure, the specific implementation can be referred to the relevant description in embodiment step 203, which will not be repeated here.

In another embodiment, referring to FIG. 11, the method includes the following steps:
Step 1001: the network side sending first auxiliary information to the terminal side.

For the embodiments of the present disclosure, the specific implementation can be referred to the relevant description in embodiment steps 501 and 601, which will not be repeated here.

For the embodiments of the present disclosure, the terminal side first needs to determine the channel sample information used for performance testing. Then, by comparing the channel sample information with the channel sample information after compression and decompression processing, it determines the first performance test information when the encoder and decoder are jointly used. The terminal side then sends the first performance test information to the network side, enabling the network side to compare the first performance test information with a preset performance requirement and determine whether the performance requirements are met when the encoder and decoder are jointly used.

When the terminal side obtains the channel sample information, as one possible implementation, the network side may send a reference signal for channel state information measurement to the terminal side, so that the terminal side can obtain the channel sample information by measuring the reference signal. In this case, the first auxiliary information sent by the network side to the terminal side may include the reference signal for measuring the channel sample information. In another embodiment, the channel sample information may also be predefined channel state information. For example, the terminal side may obtain an offline test dataset and extract channel sample information from the test dataset. The test dataset pre-stores CSI actually measured by the terminal, such as full channel information, or feature vectors processed from the full channel information. In this case, the first auxiliary information sent by the network side to the terminal side may not include the reference signal for measuring the channel sample information.

When the terminal side determines the decompressed information after decompression processing of the channel sample information, as one possible implementation, the network side may send a decoder for decompression processing to the terminal side. After compressing the channel sample information by the encoder, the terminal uses the received decoder to decompress the compressed channel sample information to obtain decompressed information. In this case, the first auxiliary information sent by the network side to the terminal side may also include the decoder for decompression processing. In another embodiment, the network side may send decompressed information obtained by decompressing the compressed channel sample information using the decoder to the terminal side. In this case, the first auxiliary information sent by the network side to the terminal side may also include the decompressed information.

Step 1002: the terminal side obtaining first performance test information when the encoder and decoder are jointly used based on the first auxiliary information.

For the embodiments of the present disclosure, the specific implementation can be referred to the relevant description in embodiment step 203, which will not be repeated here.

Step 1003: the terminal side sending second auxiliary information to the network side, where the second auxiliary information includes the first performance test information and the predicted performance requirement.

For the embodiments of the present disclosure, the specific implementation can be referred to the relevant description in embodiment step 701, which will not be repeated here.

Step 1004: the network side comparing the first performance test information with the preset performance requirement to determine whether performance requirements are met when the encoder and decoder are jointly used.

For the embodiments of the present disclosure, the specific implementation can be referred to the relevant description in embodiment step 702, which will not be repeated here.

Step 1005: the network side sending indication information to the terminal side, where the indication information is used to indicate whether performance requirements are met when the encoder and decoder are jointly used.

For the embodiments of the present disclosure, the specific implementation can be referred to the relevant description in embodiment step 703, which will not be repeated here.

In another embodiment, referring to FIG. 12, the method includes the following steps:

Step 1101: the network side sending first auxiliary information to the terminal side.

For the embodiments of the present disclosure, the specific implementation can be referred to the relevant description in embodiment steps 501 and 601, which will not be repeated here.

For the embodiments of the present disclosure, the terminal side first needs to determine the channel sample information used for performance testing. Then, it sends the channel sample information, the channel sample information compressed by the encoder, and the preset performance requirement to the network side. This enables the network side to compare the channel sample information before compression with the channel sample information compressed by the encoder to determine the second performance test information; and compare the second performance test information with the preset performance requirement to determine whether the performance requirements are met when the encoder and decoder are jointly used.

When the terminal side obtains the channel sample information, as one possible implementation, the network side may send a reference signal for channel state information measurement to the terminal side, so that the terminal side can obtain the channel sample information by measuring the reference signal. In this case, the first auxiliary information sent by the network side to the terminal side may include the reference signal for measuring the channel sample information. In another embodiment, the channel sample information may also be predefined channel state information. For example, the terminal side may obtain an offline test dataset and extract channel sample information from the test dataset. The test dataset pre-stores CSI actually measured by the terminal, such as full channel information, or feature vectors processed from the full channel information. In this case, the first auxiliary information sent by the network side to the terminal side may not include the reference signal for measuring the channel sample information.

Step 1102: the terminal side sending second auxiliary information to the network side, where the second auxiliary information includes compressed channel sample information, channel sample information before compression, and a preset performance requirement.

For the embodiments of the present disclosure, the specific implementation can be referred to the relevant description in embodiment step 702, which will not be repeated here.

Step 1103: the network side obtaining second performance test information when the encoder and decoder are jointly used based on the second auxiliary information.

For the embodiments of the present disclosure, the specific implementation can be referred to the relevant description in embodiment step 702, which will not be repeated here.

Step 1104: the network side comparing the second performance test information with the preset performance requirement to determine whether performance requirements are met when the encoder and decoder are jointly used.

For the embodiments of the present disclosure, the specific implementation can be referred to the relevant description in embodiment step 702, which will not be repeated here.

Step 1105: the network side sending indication information to the terminal side, where the indication information is used to indicate whether performance requirements are met when the encoder and decoder are jointly used.

For the embodiments of the present disclosure, the specific implementation can be referred to the relevant description in embodiment step 703, which will not be repeated here.

In another embodiment, referring to FIG. 13, the method includes the following steps:
Step 1201: the network side sending first auxiliary information to the terminal side.

For the embodiments of the present disclosure, the specific implementation can be referred to the relevant description in embodiment steps 501 and 601, which will not be repeated here.

For the embodiments of the present disclosure, the terminal side first needs to determine the channel sample information used for performance testing. Then, it sends the channel sample information and the channel sample information compressed by the encoder to the network side. This enables the network side to compare the channel sample information before compression with the channel sample information compressed by the encoder to determine the second performance test information; then send the second performance test information to the terminal side, enabling the terminal side to compare the second performance test information with a preset performance requirement and determine whether the performance requirements are met when the encoder and decoder are jointly used.

When the terminal side obtains the channel sample information, as one possible implementation, the network side may send a reference signal for channel state information measurement to the terminal side, so that the terminal side can obtain the channel sample information by measuring the reference signal. In this case, the first auxiliary information sent by the network side to the terminal side may include the reference signal for measuring the channel sample information. In another embodiment, the channel sample information may also be predefined channel state information. For example, the terminal side may obtain an offline test dataset and extract channel sample information from the test dataset. The test dataset pre-stores CSI actually measured by the terminal, such as full channel information, or feature vectors processed from the full channel information. In this case, the first auxiliary information sent by the network side to the terminal side may not include the reference signal for measuring the channel sample information.

Step 1202: the terminal side sending second auxiliary information to the network side, where the second auxiliary information includes compressed channel sample information and channel sample information before compression.

For the embodiments of the present disclosure, the specific implementation can be referred to the relevant description in embodiment step 702, which will not be repeated here.

Step 1203: the network side obtaining second performance test information when the encoder and decoder are jointly used based on the second auxiliary information.

For the embodiments of the present disclosure, the specific implementation can be referred to the relevant description in embodiment step 702, which will not be repeated here.

Step 1204: the network side sending the second performance test information to the terminal side.

For the embodiments of the present disclosure, the specific implementation can be referred to the relevant description in embodiment step 702, which will not be repeated here.

Step 1205: the terminal side comparing the second performance test information with the preset performance requirement to determine whether performance requirements are met when the encoder and decoder are jointly used.

For the embodiments of the present disclosure, the specific implementation can be referred to the relevant description in embodiment step 403, which will not be repeated here.

By applying the information processing method provided by this embodiment, in response to the encoder being deployed at the terminal side and the decoder being deployed at the network side, the terminal side and the network side can conduct performance testing when the encoder and decoder are jointly used based on the first auxiliary information or the second auxiliary information. By conducting performance testing when the encoder and decoder are jointly used before formally deploying and applying them, and only by the encoder and decoder to transmit channel state information if it is determined that performance requirements are met, thereby ensuring accurate and efficient feedback of channel state information.

FIG. 14 is a schematic structural diagram of an information processing apparatus 1400 provided by an embodiment of the present disclosure. The information processing apparatus 1400 can be applied to the terminal side.

As shown in FIG. 14, the apparatus 1400 may include:
a receiving module 1410, configured to receive first auxiliary information sent by a network side, where the first auxiliary information is used for performance testing when an encoder and a decoder are jointly used;
the encoder is deployed at a terminal side and used to compress channel state information; and the decoder is deployed at the network side and used to decompress the channel state information compressed by the encoder.

In some embodiments of the present disclosure, as shown in FIG. 14, the apparatus 1400 may include: a processing module 1420;
the processing module 1420 is configured to compress channel sample information by the encoder, where the channel sample information is channel state information used for performance testing.

In some embodiments of the present disclosure, the first auxiliary information includes a reference signal, and the receiving module 1410 is configured to receive the reference signal sent by the network side, where the reference signal is used to measure and obtain the channel sample information.

In some embodiments of the present disclosure, the channel sample information is predefined channel state information, or, the channel sample information is channel sample information sent by the network side.

In some embodiments of the present disclosure, the processing module 1420 is configured to decompress the compressed channel sample information using a decoder sent by the network side to obtain decompressed information; or, the receiving module 1410 is configured to, in response to the first auxiliary information including decompressed information, receive the decompressed information sent by the network side, where the decompressed information is information obtained by the network side decompressing the compressed channel sample information using the decoder.

In some embodiments of the present disclosure, the first auxiliary information includes the decoder, and the receiving module 1410 is configured to receive the decoder sent by the network side.

In some embodiments of the present disclosure, as shown in FIG. 14, the apparatus 1400 may include: a sending module 1430;
the sending module 1430 is configured to send the compressed channel sample information to the network side.

In some embodiments of the present disclosure, the processing module 1420 is configured to compare the decompressed information with the channel sample information before compression to obtain first performance test information when the encoder and decoder are jointly used; and compare the first performance test information with a preset performance requirement to determine whether performance requirements are met when the encoder and decoder are jointly used.

In some embodiments of the present disclosure, the sending module 1430 is configured to send the first performance test information to the network side; or send the channel sample information before compression to the network side.

In some embodiments of the present disclosure, the sending module 1430 is configured to send a preset performance requirement to the network.

In some embodiments of the present disclosure, the receiving module 1410 is configured to receive indication information from the network side, where the indication information is used to indicate whether performance requirements are met when the encoder and decoder are jointly used.

In some embodiments of the present disclosure, the receiving module 1410 is configured to, in response to the first auxiliary information including second performance test information when the encoder and decoder are jointly used, receive the second performance test information sent by the network side, where the second performance test information is obtained by the network side comparing decompressed information with channel sample information before compression; and compare the second performance test information with the preset performance requirement to determine whether performance requirements are met when the encoder and decoder are jointly used.

In some embodiments of the present disclosure, the preset performance requirement includes at least one of:
a preset value;
a performance corresponding to a Type II CSI rule;
a performance corresponding to an eType II CSI rule;
a network-side defined value; or
a terminal-side defined value.

In some embodiments of the present disclosure, the sending module 1430 is configured to send a first auxiliary performance test request to the network side, where the first auxiliary performance test request is used to request the network side to send the first auxiliary information.

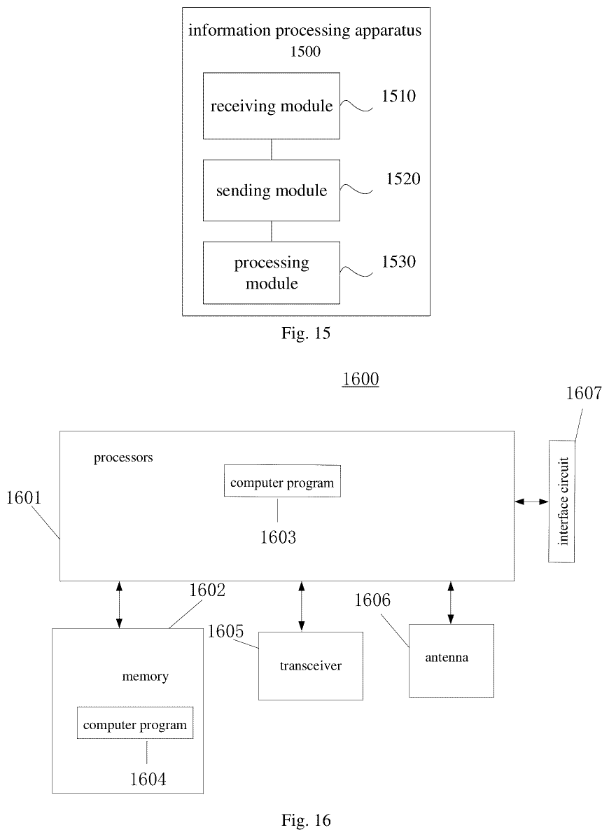

FIG. 15 is a schematic structural diagram of an information processing apparatus 1500 provided by an embodiment of the present disclosure. The apparatus 1500 can be executed by the network side.

As shown in FIG. 15, the apparatus 1500 may include:
a receiving module 1510, configured to receive second auxiliary information sent by a terminal side, where the second auxiliary information is used for performance testing when an encoder and a decoder are jointly used;
the encoder is deployed at a terminal side and used to compress channel state information; and the decoder is deployed at the network side and used to decompress the channel state information compressed by the encoder.

In some embodiments of the present disclosure, as shown in FIG. 15, the apparatus 1500 may further include: a sending module 1520;
the sending module 1520 is configured to send a reference signal to the terminal side, where the reference signal is used to measure and obtain channel sample information, and the channel sample information is channel state information used for performance testing.

In some embodiments of the present disclosure, the channel sample information is predefined channel state information, or, the channel sample information is channel sample information sent by the network side.

In some embodiments of the present disclosure, the sending module 1520 is configured to send the decoder to the terminal side, where the decoder is used by the terminal side to decompress compressed channel sample information to obtain decompressed information.

In some embodiments of the present disclosure, the second auxiliary information includes compressed channel sample information, and the receiving module 1510 is configured to receive the compressed channel sample information sent by the terminal side, where the compressed channel sample information is information obtained by compressing channel sample information by the encoder at the terminal side.

In some embodiments of the present disclosure, as shown in FIG. 15, the apparatus 1500 may further include: a processing module 1530;
the processing module 1530 is configured to decompress the compressed channel sample information using the decoder to obtain decompressed information; and the sending module 1520 is configured to send the decompressed information to the terminal side.

In some embodiments of the present disclosure, the second auxiliary information includes first performance test information when the encoder and decoder are jointly used or channel sample information before compression, and the receiving module 1510 is configured to receive the first performance test information sent by the terminal side, where the first performance test information is information obtained by the terminal side comparing decompressed information with the channel sample information before compression; or receive the channel sample information before compression sent by the terminal side.

In some embodiments of the present disclosure, the receiving module 1510 is configured to receive a preset performance requirement sent by the terminal side.

In some embodiments of the present disclosure, the processing module 1530 is configured to compare the first performance test information with a preset performance requirement to determine whether performance requirements are met when the encoder and decoder are jointly used.

In some embodiments of the present disclosure, the processing module 1530 is configured to compare the decompressed information with the channel sample information before compression to obtain second performance test information when the encoder and decoder are jointly used; and compare the second performance test information with a preset performance requirement to determine whether performance requirements are met when the encoder and decoder are jointly used.

In some embodiments of the present disclosure, the sending module 1520 is configured to send the second performance test information to the terminal device.

In some embodiments of the present disclosure, the sending module 1520 is configured to send indication information to the terminal side, where the indication information is used to indicate whether performance requirements are met when the encoder and decoder are jointly used.

In some embodiments of the present disclosure, the preset performance requirement includes at least one of:
a preset value;
a performance corresponding to a Type II CSI rule;
a performance corresponding to an eType II CSI rule;
a network-side defined value; or
a terminal-side defined value.

In some embodiments of the present disclosure, the sending module 1520 is configured to send a second auxiliary performance test request to the terminal side, where the second auxiliary performance test request is used to request the terminal side to send the second auxiliary information.

Please refer to FIG. 16. FIG. 16 is a schematic structural diagram of a communication device 1600 provided by an embodiment of the present application. The communication device 1600 may be a network device, a user device, a chip, a chip system, or a processor that supports a network device to implement the above method, or a chip, a chip system, or a processor that supports a user device to implement the above method. The device may be used to implement the method described in the above method embodiments. For details, refer to the description in the above method embodiments.

The communication device 1600 may include one or more processors 1601. The processor 1601 may be a general-purpose processor or a special-purpose processor, etc. For example, it may be a baseband processor or a central processing unit. The baseband processor may be used to process communication protocols and communication data, and the central processing unit may be used to control the communication device (such as a base station, a baseband chip, a terminal device, a terminal device chip, a DU, or a CU, etc.), execute computer programs, and process data of the computer programs.

Optionally, the communication device 1600 may further include one or more memories 1602, on which a computer program 1604 may be stored. The processor 1601 executes the computer program 1604 to cause the communication device 1600 to perform the method described in the above method embodiments. Optionally, data may also be stored in the memory 1602. The communication device 1600 and the memory 1602 may be set separately or integrated together.

Optionally, the communication device 1600 may further include a transceiver 1605 and an antenna 1606. The transceiver 1605 may be called a transceiver unit, a transceiver, or a transceiver circuit, etc., to implement a transceiver function. The transceiver 1605 may include a receiver and a transmitter. The receiver may be called a receiver or a receiving circuit, etc., to implement a receiving function. The transmitter may be called a transmitter or a transmitting circuit, etc., to implement a transmitting function.

Optionally, the communication device 1600 may further include one or more interface circuits 1607. The interface circuit 1607 is used to receive code instructions and transmit them to the processor 1601. The processor 1601 runs the code instructions to cause the communication device 1600 to perform the method described in the above method embodiments.

In an embodiment, the processor 1601 may include a transceiver for implementing receiving and sending functions. For example, the transceiver may be a transceiver circuit, an interface, or an interface circuit. The transceiver circuit, interface, or interface circuit for implementing receiving and sending functions may be separate or integrated together. The above-mentioned transceiver circuit, interface, or interface circuit may be used for reading and writing code/data, or may be used for transmitting or transferring signals.

In an embodiment, the processor 1601 may store a computer program 1603. The computer program 1603 runs on the processor 1601 to cause the communication device 1600 to perform the method described in the above method embodiments. The computer program 1603 may be solidified in the processor 1601. In this case, the processor 1601 may be implemented by hardware.

In an embodiment, the communication device 1600 may include a circuit, and the circuit may implement the sending or receiving or communication function in the foregoing method embodiments. The processor and transceiver described in the present application may be implemented in an integrated circuit (IC), an analog IC, a radio frequency integrated circuit (RFIC), a mixed-signal IC, an application-specific integrated circuit (ASIC), a printed circuit board (PCB), an electronic device, etc. The processor and transceiver may also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The communication device in the above embodiment description may be a network device or a user device, but the scope of the communication device described in the present application is not limited to this, and the structure of the communication device may not be limited by FIG. 16. The communication device may be an independent device or may be part of a larger device. For example, the communication device may be:
(1) an independent integrated circuit (IC), or a chip, or a chip system or subsystem;
(2) a set including one or more ICs. Optionally, the IC set may also include a storage component for storing data and computer programs;
(3) an ASIC, such as a modem (Modem);
(4) a module that can be embedded in other devices;
(5) a receiver, a terminal device, a smart terminal device, a cellular phone, a wireless device, a handset, a mobile unit, an in-vehicle device, a network device, a cloud device, an artificial intelligence device, etc.;
(6) others, etc.

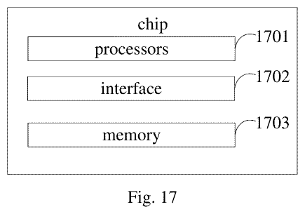

For the case where the communication device may be a chip or a chip system, refer to the schematic structural diagram of the chip shown in FIG. 17. The chip shown in FIG. 17 includes a processor 1701 and an interface 1702. The number of processors 1701 may be one or more, and the number of interfaces 1702 may be multiple.

Optionally, the chip further includes a memory 1703. The memory 1703 is used to store necessary computer programs and data.

Those skilled in the art may also understand that various illustrative logical blocks (illustrative logical blocks) and steps (steps) listed in the embodiments of the present application may be implemented by electronic hardware, computer software, or a combination of both. Whether such functions are implemented by hardware or software depends on the specific application and the overall design requirements of the system. Those skilled in the art may use various methods to implement the described functions for each specific application, but such implementation should not be understood as exceeding the scope of protection of the embodiments of the present application.

The present application also provides a readable storage medium having instructions stored thereon. When the instructions are executed by a computer, the functions of any one of the above method embodiments are implemented.

The present application also provides a computer program product. When the computer program product is executed by a computer, the functions of any one of the above method embodiments are implemented.

In the foregoing embodiments, it may be implemented entirely or partially by software, hardware, firmware, or any combination thereof. When implemented by software, it may be implemented entirely or partially in the form of a computer program product. The computer program product includes one or more computer programs. When the computer program is loaded and executed on a computer, all or part of the processes or functions according to the embodiments of the present application are generated. The computer may be a general-purpose computer, a special-purpose computer, a computer network, or other programmable devices. The computer program may be stored in a computer-readable storage medium or transmitted from one computer-readable storage medium to another computer-readable storage medium. For example, the computer program may be transmitted from a website site, computer, server, or data center to another website site, computer, server, or data center by wire (e.g., coaxial cable, optical fiber, digital subscriber line (DSL)) or wirelessly (e.g., infrared, radio, microwave, etc.). The computer-readable storage medium may be any available medium that can be accessed by a computer or a data storage device such as a server or data center integrated with one or more available media. The available medium may be a magnetic medium (e.g., floppy disk, hard disk, magnetic tape), an optical medium (e.g., digital video disc (DVD)), or a semiconductor medium (e.g., solid state disk (SSD)), etc.

The present disclosure proposes a method for processing information and apparatus, which can solve the problems of resource collision and missed beam measurement that are prone to occur when a sidelink transmits beam management signals.

Based on the present disclosure, example embodiments of this solution are as follows:
1. The terminal initiates an auxiliary performance test request to the base station.
2. Generation of test data:

In an embodiment, the base station sends CSI-RS, the terminal side measures the CSI-RS, and compresses the measurement results by the encoder on the terminal side.

In another embodiment, use an offline test dataset. This dataset includes inputs to the encoder, and the terminal compresses these input information. This test dataset can be shared by the network with the terminal. The input to the encoder can be information actually measured by the terminal, such as full channel information, or feature vectors processed from the full channel information. This is not limited here.
3. Transmission of compressed signals:

In an embodiment, use the existing CSI feedback framework to feed back the compressed information, i.e., use the method of transmitting CSI in the current NR system to transmit the compressed information. For example, send single CSI feedback through the PUCCH channel or PUSCH channel.

In another embodiment, package and feed back multiple compressed results together using PUSCH, i.e., the terminal side compresses multiple CSI samples at once and then sends the multiple compressed CSI results together to the base station instead of sending them separately.
4. Test performance determination:

In an embodiment, determined by the base station side. In this case, the terminal side sends the compressed CSI information to the base station side. If the terminal measured the CSI-RS sent by the base station, it also needs to send the pre-compression measurement information to the base station. The base station side compares the output of the decoder with the information before compression to obtain the inference performance after the encoder and decoder are connected.

In another embodiment, based on the above implementation, the terminal also needs to feed back CSI generated using traditional methods such as type II or etype II based on the measured CSI. The network can determine which is more accurate between the compressed CSI information and the CSI generated by traditional methods. Here, the traditional method also measures CSI-RS and then generates feedback CSI information according to the current NR system method for generating type II or etype II. The purpose of this judgment is to determine whether CSI compression based on AI is better than the traditional method. If the performance is worse than the traditional method, the AI model still needs to be adjusted.

In another embodiment: determined by the terminal side. The base station sends the output of the decoder to the terminal. The terminal compares the output of the decoder with the information before CSI compression to determine the inference performance.
5. The terminal side or the network side determines whether the performance meets the requirements based on the performance determination. If the requirements are met, the terminal side uses the current encoder; if the requirements are not met, the encoder is retrained.

It should be noted that the base station side can also require the terminal side to perform auxiliary testing based on the same method.

In summary, the present disclosure has the following beneficial technical effects: in response to the encoder being deployed at the terminal side and the decoder being deployed at the network side, the terminal side and the network side can conduct performance testing when the encoder and decoder are jointly used based on the first auxiliary information or the second auxiliary information. By conducting performance testing when the encoder and decoder are jointly used before formally deploying and applying them, and only by the encoder and decoder to transmit channel state information if it is determined that performance requirements are met, thereby ensuring accurate and efficient feedback of channel state information.

The embodiments or examples of the present disclosure are not exhaustive and are only illustrative of some embodiments or examples, and are not intended to specifically limit the scope of protection of the present disclosure. Where there is no conflict, each step in one embodiment or example may be implemented as an independent embodiment, and the steps may be combined arbitrarily. For example, a solution obtained by removing some steps from one embodiment or example may also be implemented as an independent embodiment, and the order of the steps in one embodiment or example may be arbitrarily swapped. In addition, optional methods or examples in one embodiment or example may be combined arbitrarily; moreover, the embodiments or examples may be combined arbitrarily. For example, part or all of the steps of different embodiments or examples may be combined arbitrarily, and optional methods or examples of one embodiment or example may be combined arbitrarily with other embodiments or examples.

In some embodiments or examples, “in response to . . . ”, “in the case of . . . ”, “when . . . ”, “if . . . ”, etc. in the present disclosure may be replaced with each other.

In some embodiments or examples, expressions such as “A or B”, “A and/or B”, “at least one of A and B”, “in one case A, in another case B”, “in response to one case A, in response to another case B”, etc. in the present disclosure may include at least one of the following technical solutions depending on the circumstances: executing A regardless of B, i.e., A in some embodiments or examples; executing B regardless of A, i.e., B in some embodiments or examples; selectively executing A or B, i.e., selecting to execute from A and B in some embodiments or examples; executing both A and B, i.e., A and B in some embodiments or examples.

In some embodiments or examples, “including A”, “containing A”, “used to indicate A”, “carrying A” in the present disclosure may be interpreted as directly carrying A, or indirectly indicating A.

In addition, each element, each row, or each column in the tables involved in the present disclosure may be implemented as an independent embodiment, and any combination of elements, rows, and columns may also be implemented as an independent embodiment.

Those of ordinary skill in the art can understand that the various numerical numbers such as first and second involved in the present disclosure are only for the convenience of description and distinction, and are not used to limit the scope of the embodiments of the present disclosure, nor do they indicate a sequence.

“At least one” in the present disclosure may also be described as “one or more”, and “multiple” may be two, three, four, or more, which is not limited in the present disclosure. In the embodiments of the present disclosure, for a technical feature, terms such as “first”, “second”, “third”, “A”, “B”, “C”, and “D” are used to distinguish the technical features within that technical feature. The technical features described by “first”, “second”, “third”, “A”, “B”, “C”, and “D” have no sequential or size order.

As used herein, the terms “machine-readable medium” and “computer-readable medium” refer to any computer program product, device, and/or device (e.g., magnetic disk, optical disk, memory, programmable logic device (PLD)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The systems and techniques described herein may be implemented in a computing system that includes background components (e.g., as a data server), or a computing system that includes middleware components (e.g., an application server), or a computing system that includes front-end components (e.g., a user computer with a graphical user interface or web browser through which a user can interact with implementations of the systems and techniques described herein), or any combination of such background components, middleware components, or front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and typically interact through a communication network. The client-server relationship arises by virtue of computer programs running on the respective computers and having a client-server relationship to each other.

It should be understood that the various forms of flows shown above may be used, and steps may be reordered, added, or deleted. For example, the steps described in this disclosure may be executed in parallel, sequentially, or in different orders, as long as the desired results of the technical solutions disclosed in this disclosure can be achieved. This is not limited herein.

In addition, it should be understood that the various embodiments of the present disclosure may be implemented alone or in combination with other embodiments when the solution permits.

Those of ordinary skill in the art may realize that the units and algorithm steps of the examples described in conjunction with the embodiments disclosed herein can be implemented by electronic hardware, or a combination of computer software and electronic hardware. Whether these functions are implemented by hardware or software depends on the specific application and design constraints of the technical solution. Professionals can use different methods for each specific application to implement the described functions, but such implementation should not be considered beyond the scope of the present disclosure.

Those skilled in the art can clearly understand that for the convenience and conciseness of description, the specific working processes of the systems, devices, and units described above may refer to the corresponding processes in the foregoing method embodiments, and will not be repeated here.

The above is only specific implementations of the present disclosure, but the scope of protection of the present disclosure is not limited thereto. Any person skilled in the art can easily think of changes or substitutions within the technical scope disclosed in the present disclosure, which should be covered within the scope of the present disclosure. Therefore, the scope of the present disclosure shall be subject to the scope of the claims.

1. A method for processing information, performed by a terminal, comprising:
receiving first auxiliary information sent by a network side, wherein the first auxiliary information is used for a performance testing in a case where an encoder and a decoder are jointly used;
wherein the encoder is deployed at a terminal side and used to compress channel state information, and the decoder is deployed at the network side and used to decompress the channel state information compressed by the encoder.

2. The method according to claim 1, further comprising:
compressing channel sample information by the encoder, wherein the channel sample information is the channel state information used for the performance testing.

3. The method according to claim 2, wherein the first auxiliary information comprises a reference signal, and the method further comprises:
receiving the reference signal sent by the network side, wherein the reference signal is used to measure and obtain the channel sample information;
wherein the channel sample information is predefined channel state information, or the channel sample information is sent by the network side.

4. (canceled)

5. The method according to claim 2, further comprising:
decompressing the compressed channel sample information using a decoder sent by the network side to obtain decompressed information; or
in response to the first auxiliary information comprising decompressed information, receiving the decompressed information sent by the network side, wherein the decompressed information is obtained by the network side by decompressing the compressed channel sample information using a decoder.

6. The method according to claim 5, wherein the first auxiliary information comprises the decoder, and the method further comprises:
receiving the decoder sent by the network side;
or,
the method further comprises:
sending the compressed channel sample information to the network side;
or,
the method further comprises:
comparing the decompressed information with the channel sample information before compression to obtain first performance test information in a case where the encoder and the decoder are jointly used; and
comparing the first performance test information with a preset performance requirement to determine whether performance requirements are met in a case where the encoder and the decoder are jointly used;
wherein the method further comprises:
sending the first performance test information to the network side; or
sending the channel sample information before compression to the network side.

7.-9. (canceled)

10. The method according to claim 1, further comprising:
sending a preset performance requirement to the network side; and
receiving indication information from the network side, wherein the indication information indicates whether performance requirements are met in a case where the encoder and the decoder are jointly used.

11. (canceled)

12. The method according to claim 10, further comprising:
in response to the first auxiliary information comprising second performance test information in a case where the encoder and the decoder are jointly used, receiving the second performance test information sent by the network side, wherein the second performance test information is obtained by comparing decompressed information with channel sample information before compression at the network side; and
comparing the second performance test information with the preset performance requirement to determine whether performance requirements are met in a case where the encoder and the decoder are jointly used.

13. The method according to claim 12, wherein the preset performance requirement comprises at least one of:
a preset value;
a performance corresponding to a Type II channel states information (CSI) rule;
a performance corresponding to an eType II CSI rule;
a network-side defined value; or a terminal-side defined value.

14. The method according to claim 1, further comprising:
sending a first auxiliary performance test request to the network side, wherein the first auxiliary performance test request is used to request the network side to send the first auxiliary information.

15. A method for processing information, performed by a network side, comprising:
receiving second auxiliary information sent by a terminal, wherein the second auxiliary information is used for a performance testing in a case where an encoder and a decoder are jointly used;
wherein the encoder is deployed at a terminal side and used to compress channel state information, and the decoder is deployed at the network side and used to decompress the channel state information compressed by the encoder.

16. The method according to claim 15, further comprising:
sending a reference signal to the terminal side, wherein the reference signal is used to measure and obtain channel sample information, and the channel sample information is channel state information used for the performance testing;
wherein the channel sample information is predefined channel state information, or the channel sample information is channel sample information sent by the network side.

17. (canceled)

18. The method according to claim 15, further comprising:
sending the decoder to the terminal side, wherein the decoder is used by the terminal side to decompress compressed channel sample information to obtain decompressed information;
or,
the second auxiliary information comprises compressed channel sample information, and the method further comprises:
receiving the compressed channel sample information sent by the terminal side, wherein the compressed channel sample information is information obtained by compressing channel sample information by the encoder at the terminal side;
or,
the second auxiliary information comprises first performance test information in a case where the encoder and the decoder are jointly used or channel sample information before compression, and the method further comprises:
receiving the first performance test information sent by the terminal side, wherein the first performance test information is information obtained by comparing decompressed information with the channel sample information before compression by the terminal side; or receiving the channel sample information before compression sent by the terminal side;
wherein the method further comprises:
comparing the first performance test information with a preset performance requirement to determine whether performance requirements are met in a case where the encoder and the decoder are jointly used.

19. (canceled)

20. The method according to claim 18, further comprising:
decompressing the compressed channel sample information by using the decoder to obtain decompressed information; and
sending the decompressed information to the terminal side.

21. (canceled)

22. The method according to claim 15, further comprising:
receiving a preset performance requirement sent by the terminal side; and
sending indication information to the terminal side, wherein the indication information is used to indicate whether performance requirements are met in a case where the encoder and the decoder are jointly used.

23. (canceled)

24. The method according to claim 18, further comprising:
comparing the decompressed information with the channel sample information before compression to obtain second performance test information in a case where the encoder and the decoder are jointly used; and
comparing the second performance test information with a preset performance requirement to determine whether performance requirements are met in a case where the encoder and the decoder are jointly used.

25. The method according to claim 24, further comprising:
sending the second performance test information to the terminal device.

26. (canceled)

27. The method according to claim 24, wherein the preset performance requirement comprises at least one of:
a preset value;
a performance corresponding to a Type II CSI rule;
a performance corresponding to an eType II CSI rule;
a network-side defined value; or
a terminal-side defined value.

28. The method according to claim 15, further comprising:
sending a second auxiliary performance test request to the terminal side, wherein the second auxiliary performance test request is used to request the terminal side to send the second auxiliary information.

29.-30. (canceled)

31. A communication device, comprising:
a transceiver;
a memory; and
a processor, connected to the transceiver and the memory, configured to control a wireless signal transmission and reception of the transceiver by executing computer-executable instructions in the memory and perform;
receiving first auxiliary information sent by a network side, wherein the first auxiliary information is used for a performance testing in a case where an encoder and a decoder are jointly used;
wherein the encoder is deployed at a terminal side and used to compress channel state information, and the decoder is deployed at the network side and used to decompress the channel state information compressed by the encoder.

32. (canceled)

33. A communication device, comprising:
a transceiver;
a memory; and
a processor, connected to the transceiver and the memory, configured to control a wireless signal transmission and reception of the transceiver by executing computer-executable instructions in the memory and perform the method for processing information according to claim 15.
